(19) United States
(12) Patent Application Publication
(10) Pub. No.: US 2025/0284129 A1
(43) Pub. Date: Sep. 11, 2025

(54) Laser-Scanning Systems with Photonic Integrated Circuits, Scanning Mirrors, and Double-Pass Configurations for Augmented Reality Glasses and LiDAR

(71) Applicant: Max-Planck-Gesellschaft zur Foerderung der Wissenschaften e.V., Munich (DE)

(72) Inventors: Wesley Sacher, Halle (DE); Hannes Wahn, Halle (DE)

(73) Assignee: Max-Planck-Gesellschaft zur Foerderung der Wissenschaften e.V., Munich (DE)

(21) Appl. No.: 19/073,313

(22) Filed: Mar. 7, 2025

Related U.S. Application Data
(60) Provisional application No. 63/562,395, filed on Mar. 7, 2024.

(51) Int. Cl. G02B 27/01

(52) U.S. Cl. CPC G02B 27/0172; G02B 2027/0112

(57) ABSTRACT

A set of laser-scanning systems for augmented reality glasses displays and LiDAR (light detection and ranging) uses photonic integrated circuits to generate multiple modulated laser beams, one or more lenses to collimate and/or focus light from the photonic integrated circuits, scanning mirrors (e.g., microelectromechanical systems (MEMS) mirrors) to scan the laser beams along two axes, and a double-pass configuration to reduce the overall size of the system and enable an inline geometry. The photonic chip has emitters distributed along a thin and narrow bridge, which may be curved. This bridge is inserted into the path of optical system, enabling the double-pass configuration with small amounts of scattering or diffraction of light that passes through/by the bridge on the second pass.

### CROSS-REFERENCE TO RELATED APPLICATION(S)

This application claims the priority benefit, under 35 U.S.C. 119 (e), of U.S. Application No. 63/562,395, filed Mar. 7, 2024, which is incorporated herein by reference in its entirety for all purposes.

### BACKGROUND

Head-mounted displays and near-eye displays for augmented reality (also referred to as mixed reality or extended reality) are transparent (see-through) glasses that overlay images generated by light engines onto the user's field of view. The light engines are typically on the periphery of the glasses and the light is guided and directed toward the user's eyes using optical combiners. An optical combiner is an optical device placed close to the eye(s) of a user, allowing the user to see augmented content, such as text or images, as well as the real world behind the optical combiner in the viewing direction of the user, at the same time. The size and weight of the optical components and systems are critical to head-mounted displays.

FIG. 1A shows a light engine 102 and waveguide combiner 108 (an optical combiner based on total internal reflection) in a head-mounted display 100a for one eye (binocular headsets use two of these). The waveguide combiner 108 is a thin (e.g., about 1 mm thick) piece of glass or plastic with an input coupler 106, pupil replication elements 107, and an output coupler 110. Light from the light engine 102 is coupled into the waveguide combiner 108 via relay optics 104 and the input coupler 106, guided by total internal reflection (TIR) at the interfaces of the waveguide combiner 108, replicated by the pupil replication elements 107, and further replicated and outcoupled toward the eye 11 by the output coupler 110. The input coupler 106, pupil replication elements 107, and output coupler 110 are typically diffractive optical elements (e.g., surface relief gratings) defined on the surface of the waveguide combiner 108.

Overall, collimated beams input to the waveguide combiner 108 are expanded and output toward the eye 11 forming an image focused at infinity (to enable observation with the relaxed eye 11), whereby collimated beams with horizontal and vertical angles (0, ø) are focused to position (x, y) on the user's retina. Since the images are focused at infinity, the display system 100a is typically characterized by an angular field of view (FOV). This angular FOV is generated by deflecting/scanning a collimated laser beam or collimating light from a two-dimensional panel display and coupling this light into the waveguide combiner.

Laser-scanning light engines have become the focus of a growing number of commercial efforts for head-mounted displays. Laser-scanning has advantages of increased brightness, image contrast, and power efficiency compared to panel microdisplays.

FIG. 1B shows a laser-scanning head-mounted display 100b. Red, green, and blue (RGB) laser beams from RGB laser diodes 120 are collimated and aligned using free-space optics, reflected off a scanning mirror system 122 (typically one or two micro-electro-mechanical systems (MEMS) mirrors), and coupled into the input coupler 106 of the waveguide combiner 108 via relay optics 104. The scanning mirror system 122 scans the collimated beam in two angular directions (θ, ϕ): a fast axis of the mirror scans lines of the FOV, and a slow axis sweeps the line across the FOV. The collimated beam is replicated and relayed to the viewer's eye.

FIG. 1C shows this FOV addressing approach. The fast axis of the scanning mirror system 122 is typically operated in resonant mode (e.g., >10 kHz) and the slow axis is linearly scanned (typically 60 Hz scan rate). During the scanning process, the RGB lasers 120 are directly modulated in intensity at rates >100 MHz to define the intensity of each point in the image. Overall, the laser beams are periodically scanned over the FOV (while modulated in intensity) at a sufficiently large rate that static images and video (with no flicker) can be observed by the viewer.

The laser-scanning approach has multiple performance trade-offs and limitations, including:
1. For a fixed fast axis mirror frequency and maximum laser modulation rate, there is a trade-off between FOV and spatial resolution, i.e., for each displayed frame, there is a maximum number of resolvable spots that can be defined due to the limited mirror and laser modulation speeds.
2. There are practical limitations on the fast axis mirror frequency. Increasing the fast axis mirror frequency involves reducing the mirror size, and hence, the beam size. This increases the divergence of the beam and compromises the operation of the optical combiner—both reducing the resolution. Beam diameters larger than 2 mm are typically required for high resolution. Roughly 30 kHz mirror frequencies are the current state of the art, but these mirrors typically require diameters of about 1 mm.
3. There are also practical limitations on laser modulation rates. Typical practical modulation rates range from 250-500 MHz. Higher-speed operation would require complex drive electronics (including high-speed digital-to-analog converters). The relaxation resonance frequency of the laser may limit the modulation rates to about 1 GHz or less.
4. The light engine is complex, has a complicated packaging procedure, and is difficult to miniaturize. There are many free-space optical components that are aligned and packaged together.

Scanning multiple laser beams (“multi-beam scanning”) is one way to alleviate the limitations due to the MEMS mirror fast axis frequency. In multi-beam scanning, multiple beams scan the FOV in parallel, multiplying the number of lines scanned per cycle of the fast axis, and the resolution scales with the number of beams. Conventional techniques to multi-beam scanning involve increasing the number of lasers in the light engine, which further increases the size, complexity, and packaging/assembly difficulty.

As an example of the limitations of the laser-scanning display approach, achieving a resolution of 2000 pixels×2000 pixels with a state-of-the-art FOV of 36°×36° (50.9° full diagonal, state-of-the-art FOVs are approximately 50° full diagonal) at a 120 Hz frame rate involves a fast axis mirror frequency of about 120 kHz and a laser modulation bandwidth of about 1 GHZ (2 ns per pixel addressing time). The mirror frequency is incompatible with a mirror diameter >0.5 mm, and the laser modulation rate would be challenging to achieve due to the complex electronics and the size limitations of head-mounted displays.

Light detection and ranging (LiDAR) uses light for three-dimensional imaging, often using invisible near infrared (NIR) light with typical wavelengths around 850 nm, 905 nm, or 1550 nm. Miniaturized LiDAR systems are used in automotive sensor and mobile device applications. LiDAR is also used in augmented reality glasses, which map the surroundings of the user such that displayed images/video are in context to those surroundings.

LiDAR based on laser scanning (where a laser beam is scanned across the scene) has better resolution and contrast than flash methods (where the entire scene is illuminated at once and a pixelated sensor detects the reflected light). In laser scanning LiDAR, the laser beam is modulated (e.g., pulsed/periodically modulated in amplitude or chirped in frequency) and differences in the arrival time/amplitude/frequency of reflected light collected by the LiDAR system enable depth measurements. Laser scanning LiDAR systems are often assemblies of discrete optical components (including lasers, MEMS mirrors, lenses, and photodetectors, like the light engines for display discussed above), posing challenges related to miniaturization and complexity of packaging/assembly. In addition, the MEMS mirrors in such systems limit the resolution, FOV, and frame rate, with faster MEMS mirrors being limited to smaller diameters (resulting in larger beam divergences and lower resolutions).

Scanning multiple beams can alleviate limitations from the MEMS mirrors, but requires multiple lasers and detection paths, increasing the size and complexity of LiDAR systems based on discrete components. Photonic integrated circuits hold promise for miniaturization and reducing packaging complexity of LiDAR systems. LiDARs based on optical phased arrays become enormously complex for ˜1 mm scale beams and may involve hundreds to thousands of phase shifters. Such demonstrations have been limited in their FOVs and resolutions compared to conventional LiDAR system based on MEMS mirrors.

### SUMMARY

Photonic integrated circuits for visible light are an emerging technology for achieving complex visible-spectrum functionalities in extremely small (chip-scale) form factors. Such circuits typically include silicon nitride (SiN), silicon oxynitride (SiON), or aluminum oxide (Al₂O₃) waveguides with silica (SiO₂) cladding—all fabricated on silicon (Si) wafers, enabling mass production. Such photonic circuits may also simultaneously operate at visible and NIR wavelengths.

The light engines disclosed here use visible-light photonic integrated circuits, also called photonic integrated circuit chips or photonic chips, that address limitations of laser-scanning light engines for augmented reality glasses and LiDAR systems. Due to the broadband transparency of the waveguide and cladding materials, the visible-light photonic chips also operate at NIR wavelengths. These visible-light and NIR photonic chips can be combined with scanning mirrors and lenses (in a double-pass configuration) for compact, multi-beam, laser-scanning systems. They can be used in light engines for augmented reality glasses, LiDAR systems, and light engines for simultaneous display and LiDAR functionalities.

An example photonic integrated circuit chip can include: a substrate formed into a base region and a curved bridge extending from the base region; lasers, integrated into the base region, to emit light; edge couplers, integrated into the curved bridge, to couple the light into free space; and waveguides, connecting the lasers to the edge couplers, to guide the light from the lasers to the edge couplers.

The base region of the photonic integrated circuit chip can be thicker than the curved bridge or the base region and the curved bridge can have the same thickness.

The edge couplers can have flat facets, curved facets, or staggered, cantilevered facets for emitting the light into free space. The edge couplers can be configured to emit parallel or non-parallel beams of light, i.e., the chief rays of the multiple beams of light (each emitted by an edge coupler) may be parallel or non-parallel. Each of the edge couplers can be configured to address a different slice of a field of view illuminated by the light. In some cases, the edge couplers are configured to emit the light in a direction parallel to an optical axis of the photonic integrated circuit chip. In other cases, each of the edge couplers is configured to emit the light in a direction normal to a curvature of a facet of that edge coupler.

The photonic integrated circuit chip can also include optical switches, integrated into the base region in optical communication with the lasers and the waveguides, to route the light from the lasers to the waveguides. Similarly, the photonic integrated circuit chip can also include optical modulators, integrated into the base region in optical communication with the lasers and the waveguides, to modulate the light.

The lasers can include a red laser to emit red light, a green laser to emit green light, and a blue laser to emit blue light, in which case the photonic integrated circuit chip can also include a wavelength multiplexer, in optical communication with the red laser, the blue laser, and the green laser, to multiplex the red light, the green light, and the blue light onto one of the waveguides.

The photonic integrated circuit chip may include actuators, operably coupled to the curved bridge, to apply stress to the curved bridge to prevent warping.

The edge couplers are further configured to couple scattered and/or reflected light from free space into the waveguides, in which case the photonic integrated circuit chip may also include photodetectors, integrated into the base region, to detect the scattered and/or reflected light. In these cases, the lasers can be configured to emit red light, green light, blue light, and near-infrared (NIR) light and the photodetectors can be configured to detected scattered and/or reflected NIR light.

In some examples, the base region is a first base region coupled to a first end of the curved bridge and the photonic integrated circuit chip includes a second base region coupled to a second end of the curved bridge.

An example photonic integrated circuit chip can be included in a light engine for an augmented reality display. This light engine may also include a waveguide combiner, at least one lens, and a beam-scanning element. In operation, the waveguide combiner, which is in optical communication with the edge couplers, couples the light from the edge couplers towards an eye of a person viewing the augmented reality display. The lens, which is in optical communication with the photonic integrated circuit chip and the waveguide combiner, couples light from the photonic integrated circuit chip into the waveguide combiner. And the beam-scanning element, which is in optical communication with the lens, scans the light across a field of view of the eye of the person viewing the augmented reality display.

The light engine can optionally include a printed circuit board or carrier supporting the photonic integrated circuit chip. The photonic integrated circuit chip and the lens can be disposed between the waveguide combiner and the beam-scanning element, with the beam-scanning element configured to reflect the light past the photonic integrated circuit chip and through the lens to the waveguide combiner. The photonic integrated circuit chip, lens, and beam-scanning element can also be in line with each other and with the waveguide combiner's input coupler. The light engine can also include two or more photonic integrated circuit chips stacked together.

All combinations of the foregoing concepts and additional concepts discussed in greater detail below (provided such concepts are not mutually inconsistent) are part of the inventive subject matter disclosed herein. In particular, all combinations of claimed subject matter appearing at the end of this disclosure are part of the inventive subject matter disclosed herein. The terminology used herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1A illustrates a conventional head-mounted display based on a light engine and waveguide combiner. The waveguide combiner relays light by total internal reflection (TIR), and the couplers and pupil replication element are typically diffractive optical elements. Multiple reflections off the surface of the pupil replication and output coupler diffractive elements result in replication of the input pupil—for an expanded output beam formed from many closely spaced copies of the input pupil (defining an eyebox).

FIG. 1B illustrates a laser-scanning head-mounted display. Red (R), green (G), and blue (B) laser beams are combined into one beam using free-space optics, scanned using a scanning mirror system (MEMS mirror in the schematic), and relayed to the input coupler of the optical combiner. The collimated beams emitted from the output coupler at different angles (θ, ϕ) form an image focused at infinity with an angular field of view (FOV).

FIG. 1C illustrates the FOV observed by the viewer showing the addressing method of the laser-scanning approach. The scanning mirror system periodically scans the laser beam over the FOV while direct modulation of the lasers sets the intensity of each pixel.

FIG. 2 illustrates an inventive photonic integrated circuit chip, or photonic chip.

FIGS. 3A and 3B illustrate a light engine system that includes the inventive photonic chip of FIG. 2 and a waveguide combiner showing the path of light from the center subset of edge couplers and the stripe of the FOV addressed by this beam and the path of light from a laterally offset subset of edge couplers and the corresponding stripe of the FOV addressed by the beam, respectively.

FIGS. 4A and 4B show front views of the photonic integrated circuit chip in front of the waveguide combiner input coupler with base regions thicker than the suspended region with edge couplers and the entire chip having one thickness, respectively. The bridge part of the photonic chip suspended in front of the input coupler is sufficiently thin to only overlap a small fraction of the millimeter-scale beam approaching the input coupler.

FIG. 4C illustrates a FOV multiplexing scheme where the multiple beams (each from a triplet/subset of R, G, B edge couplers) address stripes of the FOV. The small intra-subset pitch between R, G, and B edge couplers within a triplet leads to a small color separation between the RGB components within each stripe; this can be digitally compensated (i.e., by modifying the input image data to the light engine).

FIG. 5A shows a chip with a curved facet in addition to cutouts and extensions of the facet around edge couplers. The curvature of the facet enables the edge couplers to have different axial distances to the lens, while the cutouts and extensions enables all edge couplers to be parallel.

FIG. 5B shows a chip where the cutouts and extensions to the curved facet enable non-parallel edge couplers that are also not orthogonal to the facet curve. The facet curvature and angle of edge couplers are important degrees of freedom in simplifying the design of the lens(es) and improving the overall optical performance of the light engine.

FIG. 6A shows a chip with a curved facet without cutouts or extensions and edge couplers orthogonal to the facet curve.

FIG. 6B shows a chip with a straight facet.

FIG. 6C shows a chip with the tips of the R, G, and B edge couplers at different distances to the facet (an additional degree of freedom for correction of chromatic aberration).

FIG. 6D shows a chip with suspended cantilevers containing edge couplers extending from the facet.

FIG. 7A shows a chip with closely spaced subsets of edge couplers for generating an interlaced scan pattern.

FIG. 7B illustrates two interlaced beams. The offset between the beams is exaggerated, and in practice, the beams may only be offset by one (or few) lines. Multiple sets of interlaced beams may also be used to address separate slices of the FOV (not shown here).

FIG. 8 is a schematic of an example light engine based on the one shown in FIGS. 3A and 3B showing simulated rays traced from one of the edge coupler subsets.

FIG. 9A illustrates a light engine with the photonic chip positioned between the lens(es) and MEMS mirror together with a waveguide combiner.

FIG. 9B is a schematic of the light engine in FIG. 9A showing simulated rays traced from one of the edge coupler subsets.

FIG. 9C shows the thin bridge of the photonic chip embedded in a slot in the lens (or one of the lenses).

FIGS. 10A and 10B illustrate double-pass telecentric and monocentric optical configurations, respectively. Such double-pass configurations are also referred to herein as Type 1 optical systems.

FIG. 11 illustrates a light engine variation with double-pass relay lens(es) and separate collimation lens(es) (also referred to herein as a Type 2 optical system).

FIG. 12A shows a light engine with all components packaged together. The photonic chip and MEMS mirror are mounted on carriers or printed circuit boards (PCBs), which are mounted along with the lens in a housing designed to maintain alignment of the components. Mechanical stoppers and fasteners may be positioned at the output of the light engine for setting and maintaining a certain axial distance between the light engine output and the input coupler of an optical combiner. One or more electrical connectors (connected to the carriers/PCBs) may be positioned along the outside of the housing for sending/receiving electrical input/output signals to/from the light engine. An optical window (e.g., made of glass) may be fixed to the output of the light engine to enclose and protect the light engine components.

FIG. 12B shows the thin bridge of a photonic chip embedded in the optical window, e.g., by embedding the thin bridge in a slot cut in the window or by sandwiching the thin bridge between two windows, each with a slot.

FIG. 13 shows edge coupler subsets aligned for FOV slicing along the fast axis. This involves a 90-degree rotation of the MEMS mirror orientation relative to the variation where the FOV slicing is along the slow axis.

FIG. 14 shows photonic chips that are stacked (possibly with spacing elements in between) for FOV slicing along 2 dimensions.

FIG. 15A shows a top-down view of a photonic integrated circuit chip with optical switches connected to each laser. The number of edge coupler subsets is larger than the number of lasers per color, and the switches route laser light to the various edge couplers.

FIG. 15B illustrates a multiplexing scheme used by the photonic integrated circuit chip of FIG. 15A. Each frame of the display is divided into a number of sequential sub-frames, each corresponding to a set of edge couplers selected by the optical switches. The frame is complete after all edge couplers have been addressed and scanned their respective FOV slices.

FIG. 16 shows a photonic integrated circuit chip wherein on-chip high-speed optical modulators apply the intensity modulation required to define the brightness of each pixel (instead of direct modulation of the lasers). Here, light from each laser is split into multiple waveguides using on-chip splitter devices; each of these waveguides connects to an on-chip optical intensity modulator followed by routing waveguides connected to edge couplers for emitting the light. As an example, the optical modulators may be MZI modulators using high-speed phase shifters.

FIG. 17 shows a photonic integrated circuit chip wherein wavelength multiplexer devices are used to multiplex onto each edge coupler waveguide a red, green, and blue signal; each edge coupler then emits an RGB beam with R, G, and B coaxial.

FIG. 18 shows top-down and cross-section illustrations of tapered, inverse tapered, single layer, and bi-layer edge couplers. Single layer edge couplers (top) increase or decrease the width of the waveguide as it approaches the facet (and are terminated with a blunt tip where light is in- or out-coupled to/from the photonic chip facet). Bi-layer edge couplers (bottom) include inter-layer transitions where overlapping tapers between two waveguide layers enable light to transfer between the layers; a thicker waveguide (useful for compact on-chip photonic devices and dense waveguide routing) is coupled to a thinner waveguide layer with lower optical confinement (more ideal for engineering the optical mode and hence beam shape/divergence of emitted beams and input coupling from lasers). Inverse taper edge couplers are capable of generating round beams (with equal divergence along both transverse axes), making them especially useful as emitters for the photonic integrated circuits. Both tapered and inverse tapered edge couplers can function as the input edge couplers (for laser coupling) of the photonic chip.

FIG. 19 shows example edge couplers using partial and full etch steps (two-step etch) of a single waveguide layer to define a thin waveguide for coupling light on/off the photonic chip and a thicker waveguide for compact photonic devices and dense waveguide routing away from the facet.

FIG. 20A shows laser chips aligned to edge couplers on a photonic chip, and both are attached to a common substrate/carrier. The photonic chips may be attached to the substrate face-up or flip-chip bonded.

FIG. 20B shows laser chips coupled to edge couplers through small optics (e.g., lenses) that are also attached to the common substrate/carrier.

FIG. 20C shows laser array chips, with the set of individual lasers (with a lithographically defined pitch) alleviating packaging challenges associated with aligning many laser chips to the photonic integrated circuit chip. In butt-coupling and flip-chip bonding approaches, the optical modes at the tips of the edge couplers on the photonic chip should be closely matched to the transverse optical modes of the lasers for efficient coupling.

FIG. 21A illustrates laser chips and a photonic integrated circuit chip on a common substrate/carrier, with actuators on the photonic chip used to move the edge couplers in 1D, 2D, or 3D for optimizing the alignment of the edge couplers to the lasers.

FIG. 21B illustrates laser chips flip-chip bonded to a photonic integrated circuit chip, again with actuators on the photonic chip used to move the edge couplers in 1D, 2D, or 3D for optimizing the alignment of the edge couplers to the lasers.

FIG. 21C illustrates tunable waveguide reflectors on the photonic chip used to reflect light with tuned amplitude, phase, and/or spectrum back into the laser chips (feedback). The tunable on-chip reflectors may consist of add-drop ring resonators and loop mirrors.

FIG. 22A shows a 1D suspended cantilever actuator for aligning one or more edge couplers to lasers.

FIG. 22B shows multiple 1D cantilever actuators connected to a bridge containing the edge couplers; the multiple cantilevers may increase the robustness of the suspended structure.

FIG. 22C shows an example 2D actuator (up/down and in/out-of plane in the illustration) based on cascaded cantilever actuators (e.g., using piezoelectric or electrothermal mechanisms).

FIG. 23 illustrates a photonic integrated circuit chip (region near the lasers) with on-chip waveguide-coupled photodetectors (to monitor laser powers) and on-chip temperature sensors (to monitor laser temperatures). The temperature sensors may be formed from thin film metallic wires or doped Si wires; resistance changes with temperature. Power taps (e.g., evanescent directional couplers or multimode interference couplers) couple a small fraction of light from each waveguide to a separate waveguide-coupled photodetector.

FIG. 24 illustrates a photonic integrated circuit chip with actuators embedded in the thin bridge to compensate for out-of-plane curvature caused by material stresses from the deposited dielectric layers on the photonic chip (for waveguide cores and cladding). The actuators may be based on piezoelectric or electrothermal mechanisms.

FIG. 25A is a top-down illustration of a photonic chip with grating couplers embedded in a number of thin bridges positioned between the two bases of the photonic chip.

FIG. 25B shows a photonic chip positioned in a light engine with the normal of the photonic chip parallel to the optical axis of the light engine.

FIG. 25C illustrates a photonic chip in front of the input coupler of the waveguide combiner; the grating couplers may be angled relative to one another and their respective bridges.

FIG. 25D shows bridges curved by being sandwiched between curved faces of two opposing transparent plates/windows.

FIG. 26 illustrates transmitted and reflected optical signals for (top) time-of-flight pulsed LiDAR, (middle) amplitude modulated coherent wave (AMCW) LiDAR, and (bottom) frequency modulated coherent wave (FMCW) LiDAR.

FIG. 27 shows an integrated photonic circuit chip for FWCW or AMCW LiDAR with coherent detection. The photonic chip emits a series of diverging NIR beams from a set of edge couplers along a facet of a thin bridge region of the photonic chip; the beams are collimated and scanned by a two-axis MEMS mirror (transmitted light, e.g., as in FIG. 26). Reflections of these transmitted beams by objects being imaged follow these same paths backwards and are coupled back onto the photonic chip via their corresponding edge couplers (reflected light). Similar to the light engines shown in other figures, multiple directly modulated NIR lasers are flip-chip bonded or otherwise co-packaged with the photonic chip. Tunable on-chip reflectors deliver optical feedback to the laser chips to achieve narrow linewidths (and hence long coherence lengths). 1×2 couplers (e.g., multimode interference couplers, evanescent directional couplers) tap off a portion of the laser light (referred to as the local oscillator, LO) for interference with reflected light. A 2×2 coupler separates a portion of the reflected light for detection while passing the transmitted light forward; some portions of the transmitted and reflected light are lost in this process, but for the transmitted light, a photodetector may be positioned at one of the ports of the 2×2 coupler to detect this lost light (for laser power monitoring). The LO and portion of the reflected light separated by the 2×2 coupler are interfered by another 2×2 coupler and detected with balanced photodetectors (coherent detection). An additional frequency discriminator (e.g., an asymmetric Mach Zehnder interferometer with balanced photodetectors at its outputs) may be used to monitor the optical frequency of the laser. For FMCW LiDAR, the direct modulation of the laser chips may be chosen to modulate the optical frequency with a ramp/sawtooth or triangle waveform. For AMCW LiDAR, the lasers may be directly modulated to achieve intensity modulation with a periodic waveform (e.g., sine wave).

FIG. 28 shows another photonic integrated circuit chip for LiDAR. The reflected light is separated by the 2×2 couplers and directly detected by on-chip photodetectors (no coherent detection). This variation is compatible with AMCW LiDAR where extraction of the phase of the amplitude modulation of the reflected light is performed in the electronic domain. This variation is also compatible with pulsed time-of-flight LiDAR, where the arrival time of the reflected pulse is measured.

FIG. 29 shows yet another photonic integrated circuit chip for LiDAR. This photonic integrated circuit chip has pairs of closely spaced edge couplers. One edge coupler emits a NIR beam and the other collects the reflected light, eliminating the need for a 2×2 coupler that taps off a portion of the reflected light and the corresponding additional loss.

FIGS. 30A and 30B illustrate example LiDAR optical systems. Diverging NIR beams from the photonic chip are collimated by either one or two passes through the lens(es) and scanned by a two-axis MEMS mirror. The beams pass by the thin bridge region of the photonic chip, but are expanded at this point such that the thin bridge corresponds to only a small fraction of the beam area (and diffraction/scattering effects are minimal). Reflected NIR beams are focused by the lens(es) and directed to their respective edge couplers by the MEMS mirror. In FIG. 30A, the photonic chip is positioned after the lens(es) with the edge couplers facing the lens(es). In FIG. 30B, the photonic chip is positioned between the MEMS mirror and the lens(es), and the photonic chip may be embedded in a surface of the lens(es).

FIG. 31 shows a photonic integrated circuit chip configured for simultaneous light engine and LiDAR functionalities. Not all circuit elements are shown, and routing waveguides are not shown. Directly modulated R, G, B, and NIR lasers are flip-chip bonded or otherwise co-packaged with the photonic chip. Diverging beams are emitted from subsets of R, G, B, and NIR edge couplers along a facet of the thin bridge region of the photonic chip. Reflected NIR light is collected by the NIR edge couplers and detected (either with individual or balanced photodetectors).

FIGS. 32A and 32B illustrate systems for simultaneous light engine and LiDAR operation. R, G, B, and NIR beams are collimated by the lens(es) and scanned by the two-axis MEMS mirror. The input coupler of the waveguide combiner couples R, G, and B light into the waveguide combiner and passes NIR light with minimal coupling to the combiner. An additional optical element (e.g., lens or diffractive optical element) on the opposite side of the waveguide combiner may be used to correct for any divergence in the NIR light due to chromatic aberration. Reflected NIR beams pass through the waveguide combiner, are focused by the lens(es), and directed to their respective edge couplers by the MEMS mirror. In FIG. 32A, the photonic chip is between the lens(es) and combiner input coupler. In FIG. 32B, the photonic chip is between the lens(es) and MEMS mirror.

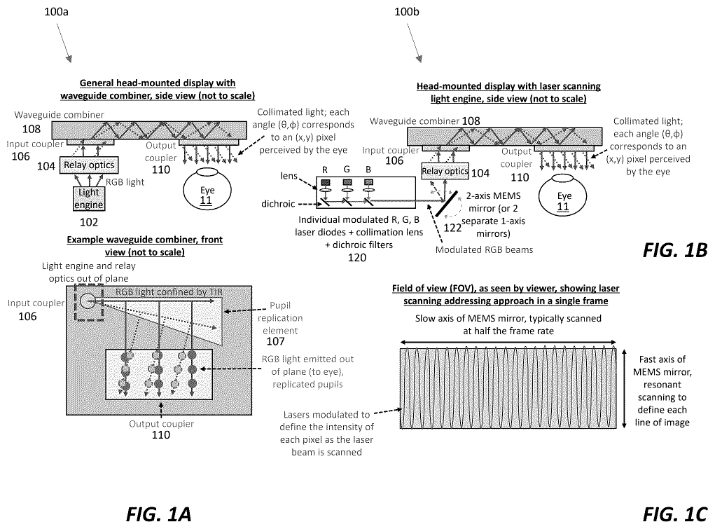

### DETAILED DESCRIPTION

### Light Engines for Augmented Reality Glasses

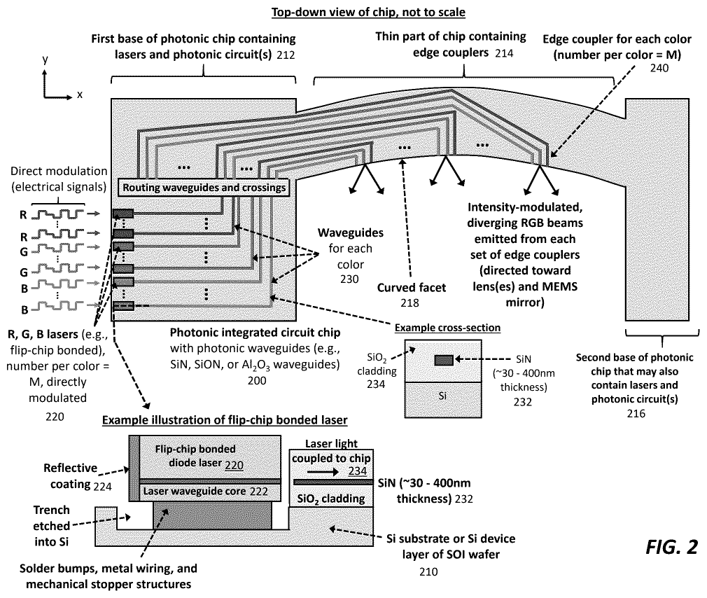

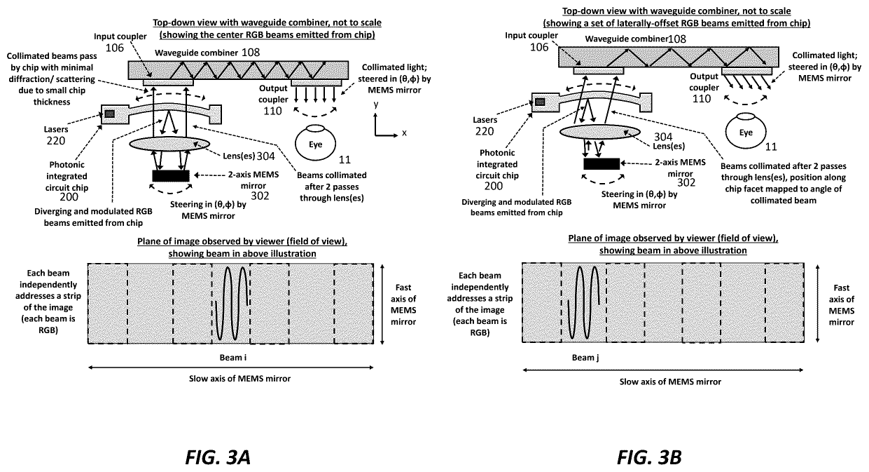

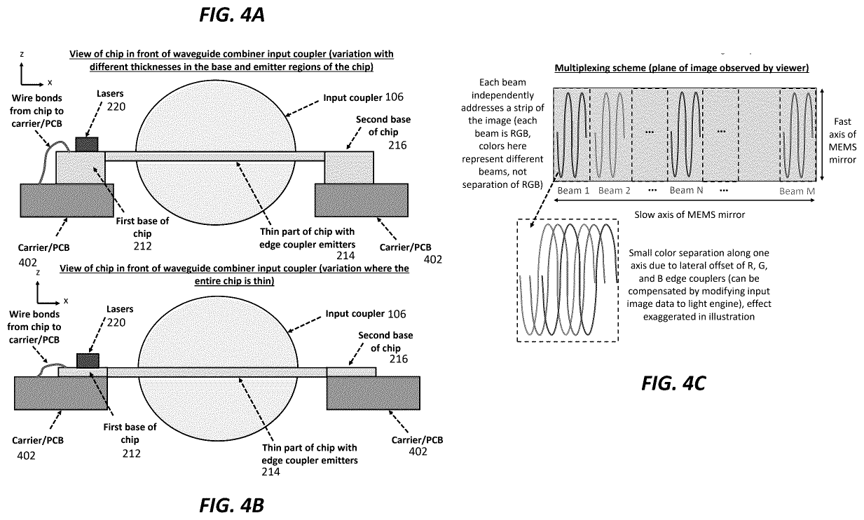

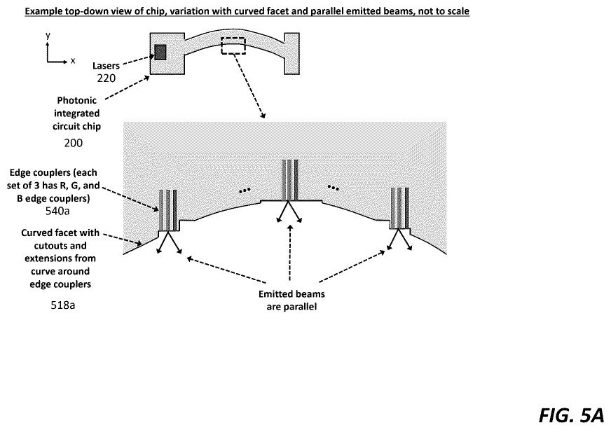

FIGS. 2-4 show inventive light engines for augmented reality glasses. FIG. 2 illustrates the photonic integrated circuit chip, FIGS. 3A and 3B show an example of the light engine together with a waveguide combiner, and FIGS. 4A-4C provide additional details about the optical system and multiplexing scheme.

FIG. 2 shows a photonic integrated circuit chip 200, or photonic chip, that includes integrated red (R), green (G), and blue (B) lasers 220 (possibly flip-chip bonded or otherwise co-packaged/integrated) on a silicon substrate 210. The photonic chip 200 includes a first base region 212, a second base region 216, and a thin bridge 214 connecting the two base regions 212, 216. The base regions 212, 216 can be used to mount the photonic chip 200 on a carrier or substrate, such as a printed circuit board (PCB) 402 (FIGS. 4A and 4B). The first base region 212 (and possibly the second base region 216) contains the lasers 220 and at least some of the photonic circuitry. The thin bridge 214 contains routing waveguides 230, edge couplers 240, and a facet 218 from which light is emitted. (Embodiments with only one base region are also possible but may be less mechanically robust since the thin bridge region of the photonic chip would be a cantilever that is not supported at one end). The facet 218 may be straight or curved as shown in FIG. 2.

The lasers 220 are directly modulated to encode pixel brightness. Each laser 220 includes a laser waveguide core 222 with a reflective coating 224 on one end and another partially reflecting end that couples light into a corresponding waveguide 230 formed of a SiN waveguide core 232 surrounded by a SiO₂ cladding 234, shown in cross section in the center of FIG. 2. Other embodiments may use aluminum oxide (Al₂O₃), silicon oxynitride (SiON), doped silica, lithium niobate, or lithium tantalate waveguides with SiO₂ cladding. SiON may also be used as the cladding rather than SiO₂. Embodiments using polymer waveguides are also possible.

Each waveguide 230 routes light from the corresponding laser 220 to a facet 218 of the photonic chip and terminates at the facet 218 with an edge coupler 240. The waveguides 230 may cross each other, and these crossings may be implemented as in-plane multimode interference waveguide crossing devices, tapered waveguide crossings, or over/under-pass crossings using multiple waveguide layers. The lasers 220 are directly modulated, and each laser 220 corresponds to one edge coupler 240 on the output facet 218—forming a set of independent intensity-modulated beams emitted from the photonic circuit chip facet 218. The edge couplers 240 may be arranged in subsets (e.g., triplets) of closely spaced edge couplers 240, one emitting red (R) light, another emitting green (G) light, and the remaining edge coupler emitting blue (B) light (with each edge coupler 240 designed for specific beam properties at its operating wavelength). The inter-subset pitch may be significantly larger than the intra-subset pitch. Each subset of edge couplers 240 effectively forms an RGB beam.

FIGS. 3A and 3B show a light engine with the photonic integrated circuit chip 200, lens(es) 304, and a two-axis MEMS mirror 302 in line with one another and the input coupler 106 of a waveguide combiner 108. Diverging RGB beams from the photonic integrated circuit chip 200 pass through the lens 304 (or lenses), reflect off the two-axis MEMS mirror 302, pass through the lens(es) 304 again, pass by the photonic chip 200, and are then incident on the input coupler 106 of the waveguide combiner 108. The beams are collimated and directed to the input coupler 106 of the waveguide combiner 108 after two passes through the lens(es) 304, and the small thickness and depth of the bridge 214 of the photonic chip 200 (with edge couplers 240) leads to minimal scattering/diffraction of the light. The diffraction and scattering effects are further reduced by placing the photonic chip 200 close to the input coupler 106, which is at or near the pupil plane of the light engine.

In greater detail, the diverging beams are emitted from the thin bridge 214 of the photonic chip 200, pass through the lens 304 (or lenses), reflect off the two-axis scanning mirror 302 (e.g., piezoelectric, electromagnetic, electrostatic, or electrothermal MEMS mirrors), make a second pass through the lens(es) 304, pass by the thin bridge 214 of the photonic chip 200, and are then coupled into the optical combiner 108 via the input coupler 106. The beams are collimated after passing through the lens(es) twice. Before reaching the input coupler, the beams intersect the thin bridge of the photonic chip, causing diffraction and scattering. These effects tend to be small because: (1) the photonic chip is positioned near the input coupler (near the pupil plane of the light engine) where the beams are expanded to millimeter-scale and collimated, and (2) the thickness and depth of the photonic chip bridge 214 are small compared to the diameter of the collimated beams as shown in FIGS. 4A and 4B. Overall, the bridge 214 of the photonic chip 200 overlaps a small fraction of the collimated beams.

Each of the beams (from a subset of edge couplers) addresses a slice of the FOV, as shown in FIG. 4C, and since each beam is independently intensity-modulated, the beams address the FOV in parallel. Since each beam addresses a smaller section of the FOV, a sufficiently large number of beams enables high-resolution and wide FOVs with relatively low fast-axis mirror frequencies and laser modulation rates. This is illustrated in Table 1, which compares the multi-beam laser-scanning approach herein (eight beams per color per eye) and a conventional laser-scanning approach with one beam per color per eye.

For a given combination of resolution and FOV, the fast-axis mirror frequency, laser modulation rate, and slow-axis deflection decrease as the number of beams increase. This alleviates the trade-off between (fast-axis mirror frequency, laser modulation rate) and (resolution, FOV). In this approach, high-resolution and wide-FOV displays are possible with reduced fast-axis mirror frequencies, and hence, larger mirrors and larger beam diameters. The edge couplers, lens(es), chip-facet-to-lens(es) distances, and lens(es)-to-mirror distances may be designed to achieve the appropriate beam diameters for this approach. The reduced laser modulation rates of this approach also reduce the complexity of the drive electronics.

Multiple laser beams may also be generated by discrete laser components. However, this approach is challenging to scale—the increasing number of discrete lasers, lenses, and filters poses alignment, packaging, and miniaturization challenges. By contrast, the approach described here relies on wafer-scale manufacturing technology and is more easily scalable. Inventive photonic circuit chips can be manufactured using wafer-scale fabrication processes, and flip-chip bonding of multiple laser dies to photonic circuit chips can be a high-yield wafer-scale assembly process (requiring no lenses for coupling the lasers to the photonic circuit chip).

TABLE 1
Comparison of multi-beam laser scanning in FIG. 4C with conventional
laser scanning (with resolution only limited by time dynamics, ignoring
resolution limits due to the beam diameter and optical combiner)
Resolution = 2000 pix. × 2000 pix., FOV = 36° × 36° (50.9° diagonal),
120 Hz frame rate

| | | | Conventional |
|---|---|---|---|
| | Multi-beam approach | | approach |
| | (8 beams per color | | (1 beam per color |
| | per eye) | | per eye) |
| Fast-axis mirror frequency | 15 | kHz | 120 kHz (requires |
| | | | very small mirror |
| | | | diameters) |
| Fast-axis mirror | ±9° | | ±9° |
| mechanical deflection | | | |
| Slow-axis mirror frequency | 60 | Hz | 60 Hz |
| Slow-axis mirror | ±1.125° | | ±9° |
| mechanical deflection | | | |
| Pixel addressing time | 16.67 | ns | 2.08 ns (requires |
| | | | complex electronics) |

The double-pass configuration enables a reduction in the size and number of lenses compared to other light engines based on photonic integrated circuits where the light makes a single pass through the optical system. In addition, the optical elements are arranged in a line (“inline” geometry), enabling further reductions in light engine volume compared to light engines with a folded optical path. In this approach, the relaxed scanning mirror fast-axis frequency and slow-axis deflection specification circumvent challenges in the beam quality and control of two-axis MEMS mirrors that often preclude their use in conventional laser scanning light engines (often such light engines use two single-axis MEMS mirrors).

One design parameter is the edge coupler pitch in FIG. 2. In this example, subsets of edge couplers 240 for R, G, and B beams are on a small pitch, and the pitch between subsets of edge couplers 240 is larger. The intra-subset pitch sets the separation/offset between R, G, and B beams within an FOV slice in FIG. 4C. This offset can be made small (e.g., down to one or a few lines) using a small intra-subset pitch, and the minimum pitch is limited by optical crosstalk between edge couplers; a practical range of intra-subset pitches is 0.7-20 μm.

Furthermore, the offset can be digitally compensated by adjusting the image data input to the display system, for example, by shifting the R, G, and B color components of the input images to align the color components of the final image observed by the viewer. The larger inter-subset pitch is designed to achieve a certain FOV. Together with the collimation/relay optics, this pitch sets the spacing of FOV slices (FIG. 4C). The beams within each FOV slice may slightly overlap their neighboring slices to avoid gaps in the FOV, the laser intensity may be adjusted in these overlapped regions for uniform brightness of the overall image, and the beams may form an interlaced pattern within these overlap regions.

The first and second bases 212, 216 of the photonic chip 200 may be used to mount the photonic chip 200 on carriers or PCBs 402 with the thin bridge 214 of the photonic chip 200 suspended in between as shown in FIGS. 4A and 4B. The base(s) 212, 216 of the photonic chip 200 may be wire bonded to the carrier/PCB 402. The base regions 212, 216 may be thicker than the thin bridge 214, as in FIG. 4A, or the base and bridge regions may be of the same thickness, as in FIG. 4B.

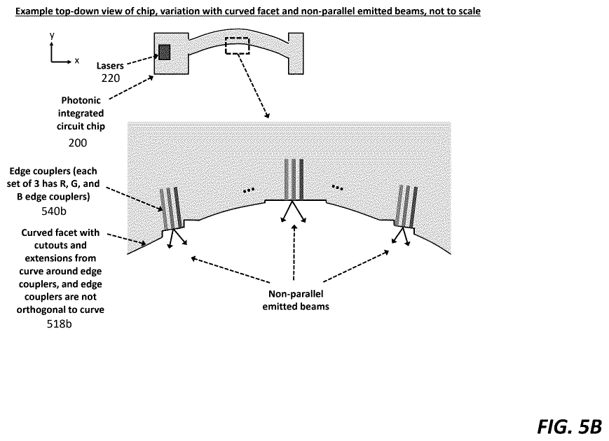

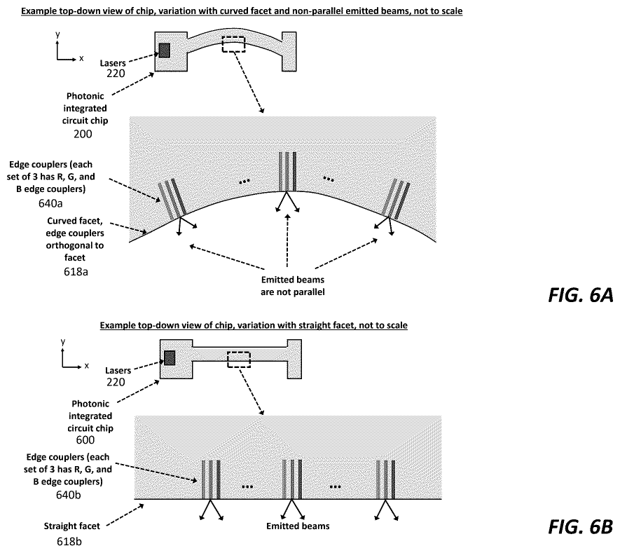

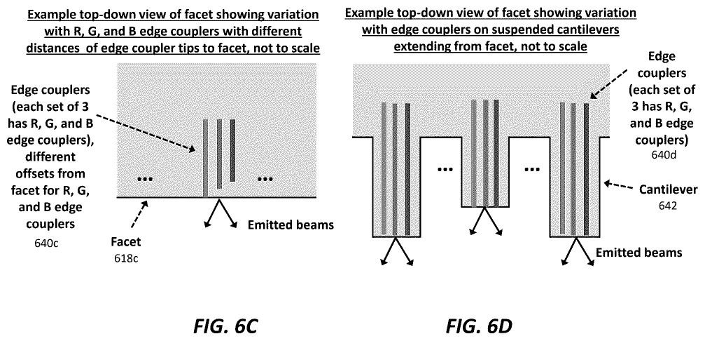

FIGS. 5A, 5B, and 6A-6D show variations and details of output facets of inventive photonic chips and edge couplers. Degrees of freedom include the axial positions of the edge coupler tips (where light is emitted) and the in-plane angles of the edge couplers relative to the optical axis of the light engine. These degrees of freedom, which can be set precisely by lithography, simplify the lens design for given beam quality requirements, e.g., by relaxing constraints for the correction of optical aberrations such as field curvature or lateral color.

In FIG. 5A, the facet 518a is curved to set the axial positions of edge couplers 540a. The facet 518a deviates locally from this curvature around the subsets of edge couplers 540a (by means of cutouts and extensions) such that all edge couplers 540a are parallel to one another and orthogonal to the facet 518a locally, enabling a telecentric design. In FIG. 5B, the cutouts and extensions of the facet 518b may be designed for non-parallel edge couplers 540b, where each subset of edge couplers 540b achieves a certain angle relative to the optical axis of the light engine, is locally normal to the facet 518b, and has an axial offset set by the overall facet curvature.

In FIG. 6A, the facet 618a is curved and the subsets of edge couplers 640a are orthogonal to the curved facet 618a (for a monocentric design). In FIG. 6B, the facet 618b is straight (possibly with cutouts and extensions to angle the edge couplers 640b relative to the facet 618b). In FIG. 6C, the tips of edge couplers 640c within each subset have relative offsets to the facet 618c (possibly as an additional degree of freedom for correction of chromatic aberration), and in FIG. 6D, cantilevers 642 containing part or all of the edge couplers 640d extend from the facet (to provide additional space for waveguide bends and edge couplers tapers). Differences between the telecentric and monocentric designs are described below.

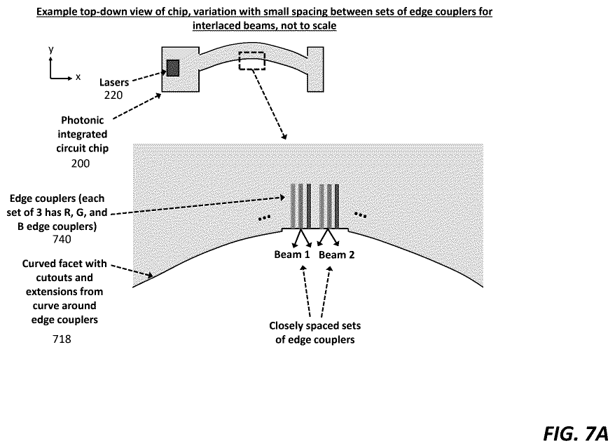

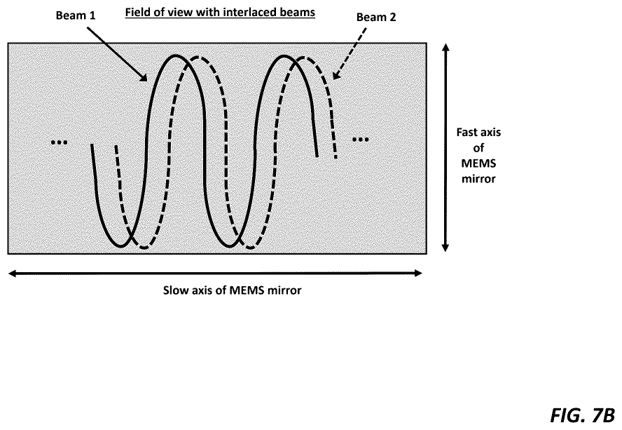

As shown in FIG. 7A, multiple subsets of edge couplers 740 are placed at a small pitch along the facet 718 such that the edge couplers' respective slices of the FOV overlap, forming an interlaced pattern for increased line density, and hence, resolution. Such embodiments include designs where the entire FOV is addressed by a number of interlaced beams, and also, designs where the FOV is addressed in slices by a number of sets of interlaced beams.

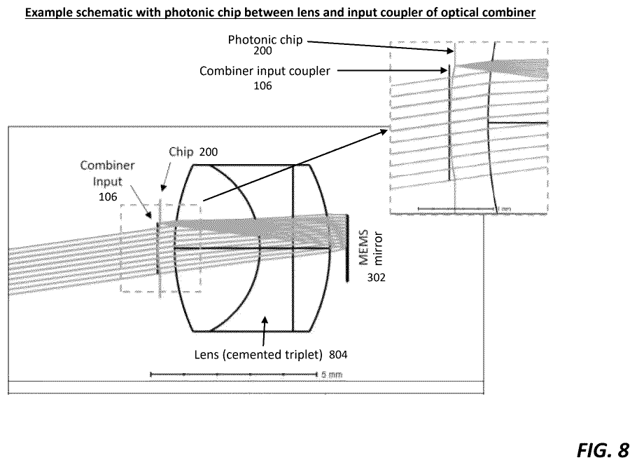

FIG. 8 shows an example schematic of a simulated version of the light engine shown in FIGS. 3A and 3B. It shows rays traced from one subset of edge couplers in the photonic chip 200. The photonic chip 200 is close to the input coupler 106 of the optical combiner 108, and the lens is a cemented triplet 804. The axial distance between the combiner input coupler 106 and surface of the two-axis MEMS mirror 302 is about 6 mm (a relatively compact light engine). The footprint of the light engine can be further reduced and the optical performance further improved by allowing additional degrees of freedom in the optical design as described below.

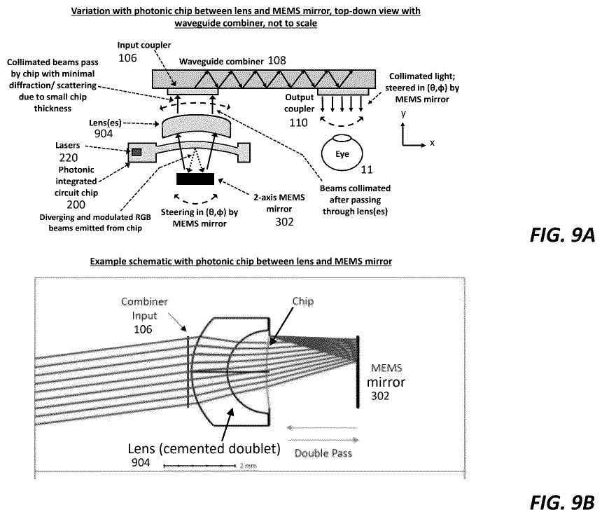

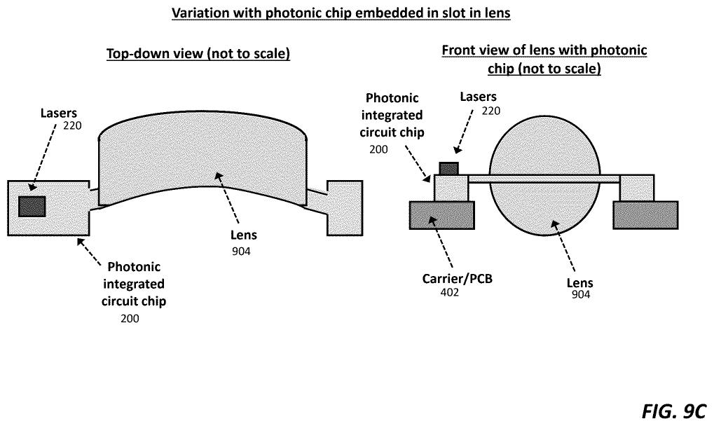

FIGS. 9A-9C show a variation of the light engine where the photonic chip 200 is positioned between the lens(es) 904 and MEMS mirror 302. In this variation, the light passes through the lens(es) 904 once. Also, it is possible to directly attach the thin bridge 214 of the photonic chip 200 to the lens 904 or a slot cut in the surface of the lens 904 as shown in FIG. 9C.

As used herein, the term “lens” includes any beam-forming element (used in transmission), made of a suitable substrate, with at least one optical surface contributing to a desired optical functionality, such as collimation or focusing of a laser beam. More specifically, a lens can be a refractive lens (spherical or aspherical), diffractive lens, metasurface lens, or combination thereof. A lens can have but does not need macroscopically curved surfaces; pure diffractive or metasurface lenses, for example, may be defined by micro- or nanostructures on an otherwise plane substrate. Likewise, a refractive lens (with at least one macroscopically curved surface) may additionally include one or more diffractive surfaces or metasurfaces. A lens with both refractive and diffractive surfaces is often referred to as a hybrid lens. Furthermore, a lens can include cemented or air-spaced interfaces, thereby generating optical groups in a functional sense.

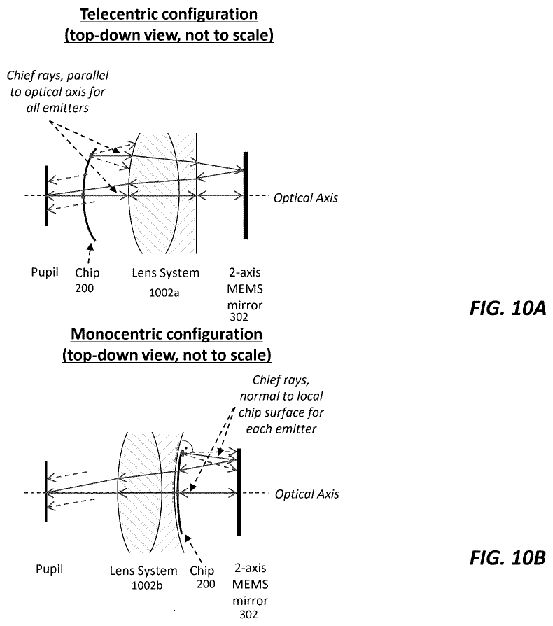

The displays disclosed herein can include two types of optical systems, both based on emitters located on a curved photonic chip facet. FIGS. 10A and 10B show different versions of the first type of optical system (Type 1) with collimation lens(es) 1002a and 1002b, respectively, to collimate the beams and direct them to a pupil. The term “pupil” as used herein refers to a region in the optical system in which collimated beams sent out from the light engine at different angles fully or partly overlap so that the eye of the user (possibly via an optical combiner) is able to receive all the collimated beams simultaneously, thus generating the FOV. The collimated beams are coupled to the optical combiner (not shown), for example, by positioning the input coupler of a waveguide combiner at the pupil.

Type 1 has collimation optics used in a single-pass configuration (FIGS. 9B and 10B) or a double-pass configuration (FIGS. 8 and 10A), including at least one optical group possibly with one or more cemented interfaces (e.g., two cemented doublets with an airspace between them or a cemented triplet). Type 1 can have a small footprint and example configurations may have up to four optical elements (each of which may include spherical, aspherical or diffractive surfaces or combinations thereof), in at most two groups, which significantly lowers the effort of manufacturing and alignment. This type is limited to smaller FOVs compared to Type 2 systems described below (approx. 30 deg. full diagonal FOV in the example schematics in FIGS. 9B and 8, each of which have only spherical surfaces); the collimated beam diameter is up to approximately 2 mm in these examples. The smaller FOV of Type 1 systems is due to the simplified optical structure, which leads to a lateral shift of the collimated beam positions in the pupil plane over the FOV depending on the MEMS mirror deflection angle.

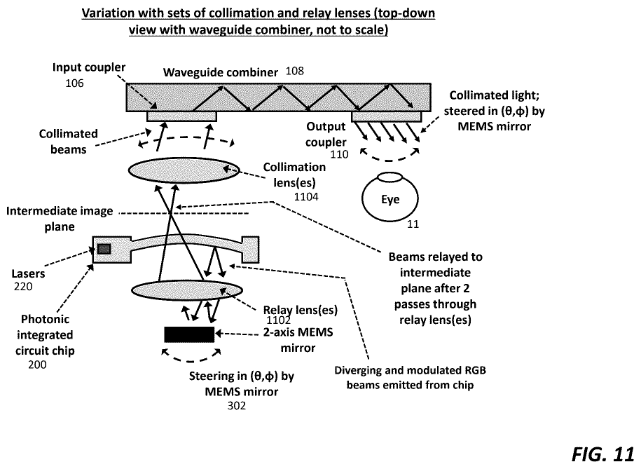

Type 2 has combined double-pass relay and collimator optics, including a real intermediate image plane. FIG. 11 shows an example Type 2 system, with one or more relay lenses 1102 that focus the beams to an intermediate image plane, and then the beams are collimated with one or more collimation lenses 1104 and coupled to the waveguide combiner 108. Type 2 systems typically use a field lens (i.e., a lens placed close to an image plane) near the intermediate image plane; the field lens is omitted from FIG. 11 for clarity.

Type 2 allows for larger FOVs and beam diameters (up to approximately 50 deg. full diagonal FOV and 3 mm beam diameters in simulation), as well as better optical correction, at the expense of a larger footprint and more complex optical structure (a larger number of optical elements and/or groups than Type 1, possibly with aspheric or diffractive surfaces). In the double-pass configurations for layouts of Type 2, the path length given by the double-pass section (beam path from chip to MEMS mirror and back to the photonic chip plane) alone often corresponds to up to half the total path length of the overall system. Thus, a significant reduction in total length is achieved compared to an equivalent configuration without double pass.

Since inventive photonic chips allow for emitters located on spherically or aspherically curved surfaces, the effort of correcting field curvature is lower for the Type 1 and Type 2 optical systems, enabling optical configurations with smaller footprints, fewer optical elements, and/or higher optical performance. Deviating from a purely spherical chip facet curvature profile by adding a conic constant or higher-order aspheric coefficients allows for balancing higher-order field aberrations of the optical system. Besides these advantages, there is the additional degree of freedom of defining the emission direction (chief ray angle) of each emitter, as shown in FIGS. 10A and 10B.

As for the combination of photonic chip facet curvature profiles and emission directions of emitters, telecentric and monocentric configurations are of particular interest. The telecentric configuration (Type 1, FIG. 10A) is used in the optical arrangement of FIG. 8, the term telecentric indicating that the emission directions of the emitters are parallel to the optical axis, independent of the normal of the overall facet curve. This configuration is commonly adopted for optical collimators used with flat-surface 2D panel display engines. For the present technology there is the additional flexibility of defining the axial position of each emitter separately, with the above-mentioned advantages.

In the monocentric configuration (Type 1, FIG. 10B), the emission direction of each emitter is normal to the local chip facet curve. This implies, for a spherically curved chip facet, that the chief rays of the emitters are directed towards the center of curvature of the photonic chip. In this context, the term monocentric refers to the properties of the photonic chip facet; the optical system is not necessarily monocentric.

The telecentric configuration decouples the axial and angular emitter orientations in the sense that the axial distance of the pupil from the photonic chip is given by the lens system, since the emission directions do not necessarily converge towards a common center (pupil) introduced by the photonic chip itself as shown in FIG. 10A. As a result, the telecentric configuration is preferably used with a lens system located between the photonic chip and MEMS mirror (double pass), as shown in FIG. 8. Furthermore, the telecentric configuration enables constant magnification for all axial emitter positions. The telecentric configuration may be achieved with the facet and edge coupler configuration in FIG. 5A.

FIG. 10B shows that for the monocentric configuration, the emission directions introduced by the photonic chip converge without additional optics. The monocentric configuration is used in single-pass and double-pass configuration (in setups without and with optical elements between the photonic chip and MEMS mirror, respectively). This configuration arises naturally from the combination of a non-telecentric system with a curved surface of emitters. The monocentric configuration may be achieved with the facet and edge coupler configuration in FIG. 6A. Furthermore, both the telecentric and monocentric configurations allow for a convenient parametric description and layout of the photonic chip facet and edge couplers. Overall, the spatio-angular properties of the photonic chip should match the properties of the optical system, and the inventive photonic integrated circuit chips offer great flexibility in this respect.

The discussion above of telecentric versus monocentric designs focuses on examples of Type 1. Both telecentric and monocentric designs are possible with optical systems of Type 2.

In FIG. 8 (telecentric, Type 1), a cemented triplet lens 804 with spherical surfaces includes a high-refractive-index optical element cemented between two lower-index elements, with the outer shape of the triplet being bi-convex. The chip-end cemented interface is strongly curved (dispersive), mainly serving correction of axial color and spherical aberration, while the MEMS mirror end cemented interface is plano or of low optical power, mainly correcting lateral color shift. The spherical base radius of curvature of the photonic chip 200 is approximately equal to the focal length of the triplet 804, which corresponds to the amount of field curvature of the optical system. The system is telecentric in object space (chip end). The optical surfaces of the triplet 804 (or other double pass system) serve different functions in terms of optical aberration correction for the two passes, which leads to a parameter coupling to be considered during design.

In the example in FIG. 9B (monocentric, Type 1), the cemented doublet lens 904 with spherical surfaces includes a low-refractive-index optical element cemented to the photonic chip 200 on one side (MEMS mirror end), and a high-refractive-index material for the other element. The strong cemented interface (dispersive) mainly serves correction of axial color and spherical aberration. This configuration offers fewer degrees of freedom for the optical design compared to the approach shown in FIG. 8, since cementing the curved photonic chip 200 to an optical surface of the lens 904 (which should be of the same radius of curvature as the photonic chip 200) introduces a coupling of these radii. One advantage is a fully integrated interface for mechanically securing the photonic chip 200 without the need for a separate chip carrier substrate.

For the system in FIG. 8, the waveguide combiner (not shown) may also mechanically support the photonic chip 200. While the layout in FIG. 9B uses only two lens elements in one group, manufacturing can be simplified, e.g., by adding one more cemented surface (cemented triplet lens instead of cemented doublet), keeping the overall optical configuration. Also, the thin curved photonic chip overlaps with beams not being fully expanded and collimated after deflection by the MEMS mirror 302 in this configuration, while the approach shown in FIG. 8 helps reduce possible interference artifacts caused by this interaction by placing the photonic chip 200 in the same plane as the pupil (or very close to this plane). In this plane the beams are fully expanded and collimated, which offers the largest amount of decoupling in this sense.

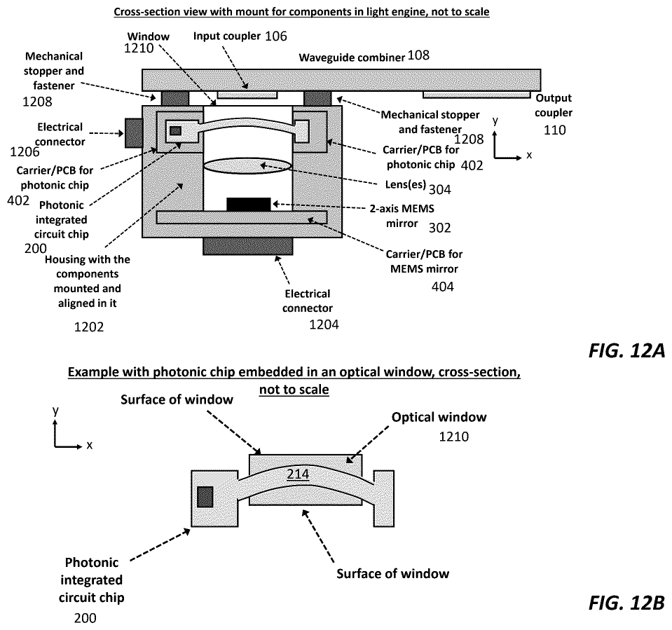

FIGS. 12A and 12B show an example of the components of the light engine packaged together. The photonic chip 200 and MEMS mirror 302 are mounted on carriers/PCBs 402, 404, which are mounted along with the lens 304 in a housing 1202 designed to maintain alignment of the components. Mechanical stoppers and fasteners 1208 may be positioned at the output of the light engine for setting and maintaining a certain axial distance between the light engine output and the input coupler of an optical combiner. One or more electrical connectors 1204, 1206 (connected to the carriers/PCBs 402, 404) may be positioned along the outside of the housing 1202 for sending/receiving electrical input/output signals to/from the light engine. An optical window 1210 (e.g., made of glass) may be fixed to the output of the light engine to enclose and protect the light engine components. As shown in FIG. 12B, the thin bridge 214 of the photonic chip 200 may be embedded in the optical window 1210, e.g., by embedding the thin bridge 214 in a slot cut in the window or by sandwiching the thin bridge 214 between two windows, each with a slot. The overall system could also include driving and control electronics for modulating the laser diodes and scanning the MEMS mirror.

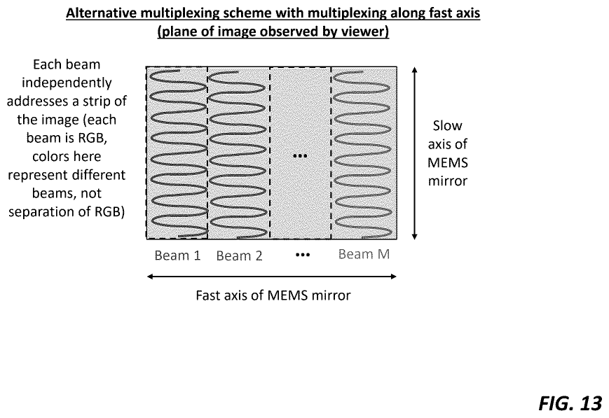

FIG. 13 shows a multiplexing scheme for a variation of the light engine where the array of edge couplers and corresponding slices of the FOV span the fast axis of the scanning mirror. In that case, the fast axis mechanical deflection is reduced by a factor equal to the number of lasers per color, while the slow axis mechanical deflection may be the same as in conventional laser scanning approaches.

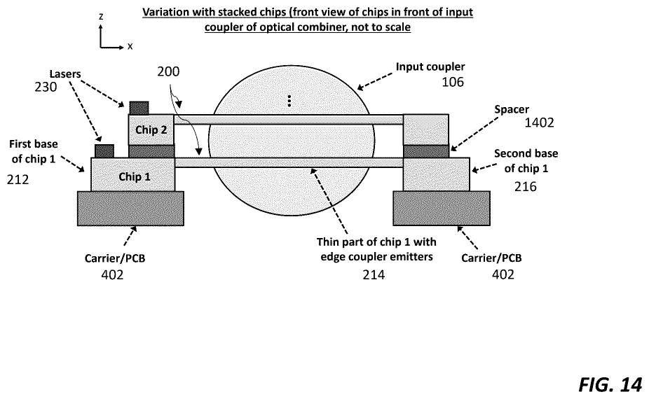

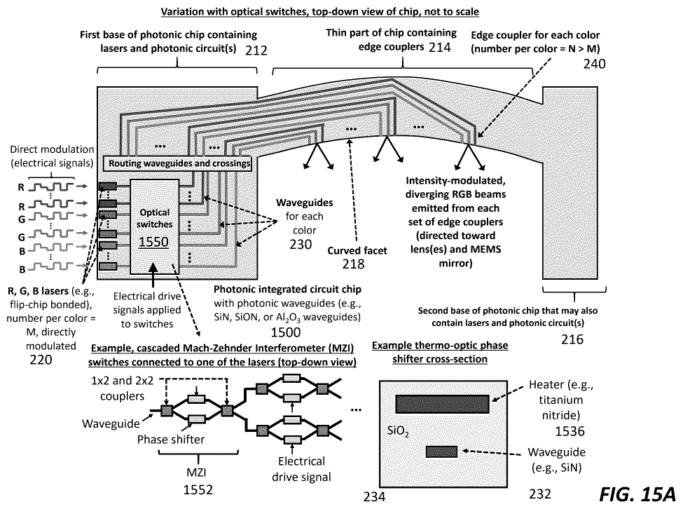

FIG. 14 shows a light engine with two photonic chips 200 stacked on top each other, optionally separated by spacers 1402 in between to slice the FOV in two dimensions. The bases 212, 216 of the second photonic chip 200 are mounted to the bases 212, 216 of the first photonic chip 200 (optionally with spacers 1402 in between), and the bases 212, 216 of the first photonic chip 200 are mounted to a carrier/PCB 402. The thin bridges 214s of both photonic chips 200 are suspended in between to emit light to the input coupler 106.

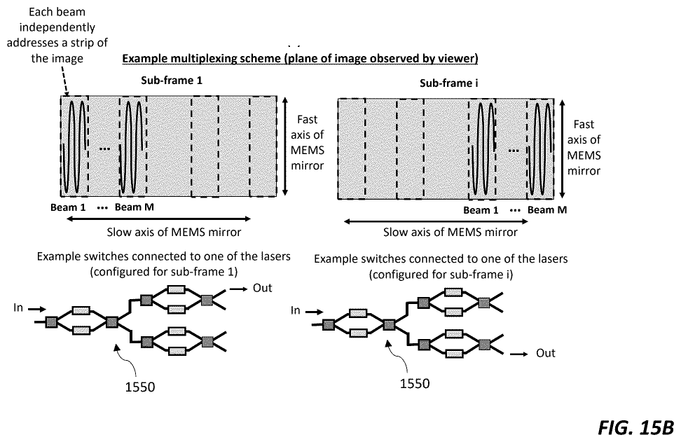

TABLE 2
Comparison of multi-beam laser scanning with additional optical switches
in FIGS. 15A and 15B with conventional laser scanning (with resolution
only limited by time dynamics, ignoring resolution limits due to beam
diameter and optical combiner)
Resolution = 2000 pix. × 2000 pix., FOV = 36° × 36° (50.9° diagonal),
120 Hz frame rate

| | Multi-beam approach | | |
|---|---|---|---|
| | (8 beams per color | | Conventional |
| | per eye, | | approach |
| | 1 × 4 switch connected | | (1 beam per color |
| | to each laser) | | per eye) |
| Fast-axis mirror frequency | 15 | kHz | 120 kHz (requires |
| | | | very small mirror |
| | | | diameters) |
| Fast-axis mirror | ±9° | | ±9° |
| mechanical deflection | | | |
| Slow-axis mirror frequency | 240 | Hz | 60 Hz |
| Slow-axis mirror | ±0.281° | | ±9° |
| mechanical deflection | | | |
| Pixel addressing time | 16.67 | ns | 2.08 ns (involves |
| | | | complex electronics) |
| Optical switching frequency | 240 | Hz | — |

FIGS. 15A and 15B show a photonic chip 1500 with on-chip switches 1550 driven synchronously with the MEMS mirror (not shown) and laser modulation. The optical switches 1550 may be implemented as cascaded 1×2 Mach-Zehnder interferometers 1552 with the input from one laser 220 switched among a number of output waveguides 230. Each Mach-Zehnder interferometer 1552 has a phase shifter in one or both arms that is driven to route light to one of the two output waveguides 230. An example thermo-optic phase shifter with a thin film heater 1536 in thermal communication with the waveguide core 232 is also shown in FIG. 15A. MEMS waveguide phase shifters may also be used.

The optical switches 1550 enable performance benefits related to many edge couplers 240 without requiring an equally large number of lasers 220. Here, the slow-axis of the MEMS mirror and on-chip switches 1550 work together to trace out the “overall slow-axis” of the display system. In FIGS. 15A and 15B, M beams (for each color) corresponding to the M lasers 220 (for each color), trace out slices of the field of view via deflection by the two-axis MEMS mirror. The slow-axis of the MEMS mirror operates at a frequency larger than the refresh rate of the display such that sub-frames are addressed by the set of beams. For each sub-frame, the optical switches 1550 are driven to route the input laser signals to different subsets of edge couplers 240. The MEMS mirror fast axis frequency, MEMS mirror slow axis deflection, and laser modulation frequency are much lower than in conventional laser scanning. TABLE 2 shows the significant performance benefits for eight lasers 220 per color per eye and a 1×4 switch connected to each laser. This comes at the expense of a higher MEMS mirror slow-axis frequency than conventional laser scanning displays, but the frequency remains practical.

Overall, compared to conventional laser scanning, the approach in FIGS. 15A and 15B scales down the slow-axis mechanical deflection by a factor of 1/(number of subsets of edge couplers 240), scales down the MEMS mirror fast axis frequency by 1/(number of lasers per color per eye), scales up the pixel addressing time by a factor of the number of lasers 220, and scales up the MEMS mirror slow axis frequency by a factor of (number of subsets of edge couplers/number of lasers 220 per color per eye).

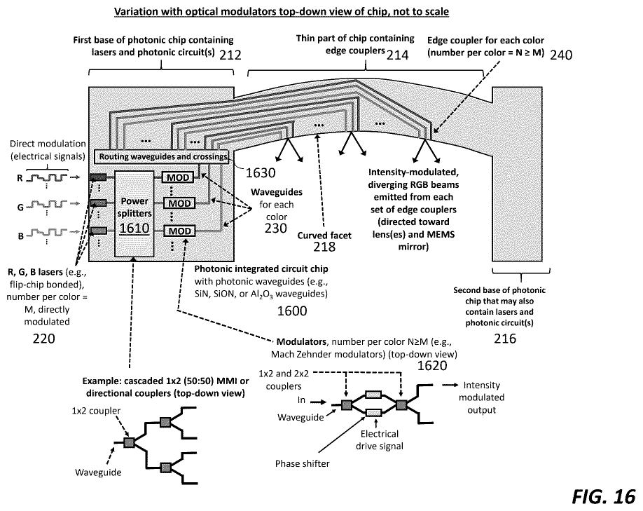

FIG. 16 shows a photonic chip 1600 with high-speed optical modulators 1620 that impart intensity modulation on the laser light (instead of direct modulation of the laser diodes 220). Optical splitting devices 1610 (e.g., cascaded 1×2 multimode interferometer or evanescent directional coupler splitters) split light from each laser 220 into multiple waveguides 230, each connecting to one optical modulator 1620, which operate at maximum modulation rates of about 100-500 MHz. The modulators 1620 may be formed from microelectromechanical (MEMS) phase shifter devices; semiconductors, such as gallium nitride (GaN); or electro-optic materials, such as barium titanate (BTO), lithium niobate, or lithium tantalate. Additional direct modulation of the lasers 220 may be used to turn off the laser in empty regions of the image.

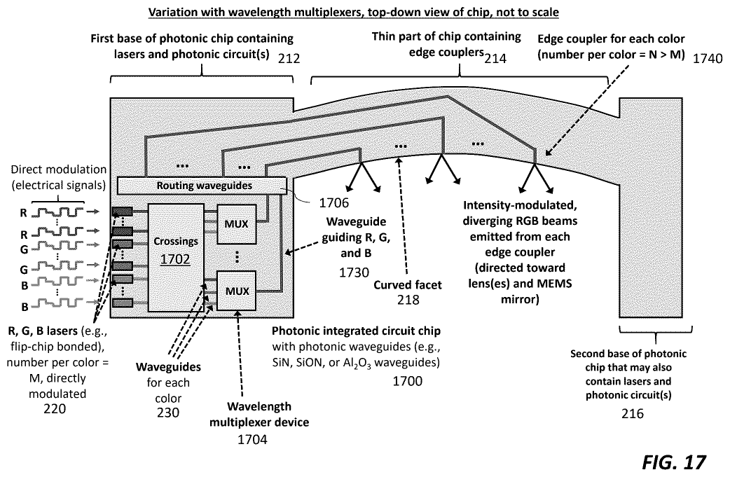

FIG. 17 shows a photonic chip 1700 that uses on-chip RGB wavelength multiplexer devices 1704 to combine light from one set of R, G, and B lasers 220 onto each edge coupler waveguide 1730. Waveguides 230 for each laser 220 guide the light from the lasers 220 to the multiplexers 1704 via one or more waveguide crossing 1702. The multiplexers 1704 are coupled to waveguides 1730 that each guide R, G, and B beams via routing waveguides 1706 to edge couplers 1740 distributed along the curved facet 218 of the bridge 214 of the photonic chip 1700. The emitted light from each edge coupler 1740 includes co-axial R, G, and B beams, in contrast to FIG. 2, which uses a separate edge coupler 240 for each R, G, and B beam. This approach may eliminate the offset between R, G, and B beams noted in FIG. 4C at the expense of additional photonic integrated circuit complexity and optical loss. The wavelength multiplexer devices 1704 may be arrayed waveguide gratings, evanescent directional couplers, ring resonators, or echelle gratings.

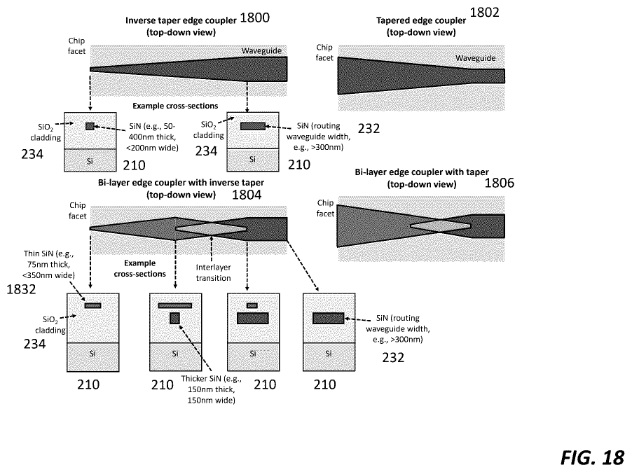

FIG. 18 illustrates different edge couplers 1800, 1802, 1804, and 1806.

Overall, the edge couplers should be designed to operate together with the lens(es) to achieve certain beam diameters with the chosen FOV. Moderate divergence angles may be beneficial here, since very small divergence angles typically propagate over larger distances to reach a ˜1-3 mm beam diameter, while very large divergence angles typically lead to more complex high-numerical-aperture collimation optics. The divergence may be specified by a numerical aperture (NA) of the edge coupler. A reasonable range of NA values is 0.05-0.40 (with 0.08-0.25 being a particularly practical range from the perspective of edge coupler and lens design).

In addition, the edge couplers should ideally emit beams with equal divergences along both transverse axes (“circular” beams) to simplify the design of the lens(es). This can be achieved with thin SiN or Al₂O₃ waveguides that are tapered to a small width at the facet (inverse tapers) like the edge coupler 1800 shown at upper left in FIG. 18. Given the relatively large refractive index difference between these materials and the SiO₂ cladding, this typically involves thicknesses of <100 nm, which may not be ideal for compact photonic devices due to the low optical confinement at such thicknesses.

Alternatively, bi-layer edge couplers 1804, 1806 can be used as shown in the bottom row of FIG. 18. In these bi-layer edge couplers 1804, 1806, light transitions from a thicker waveguide layer 232 (with higher optical confinement for compact devices) to a thinner waveguide layer 1832 with a thickness specifically chosen for the edge coupler.

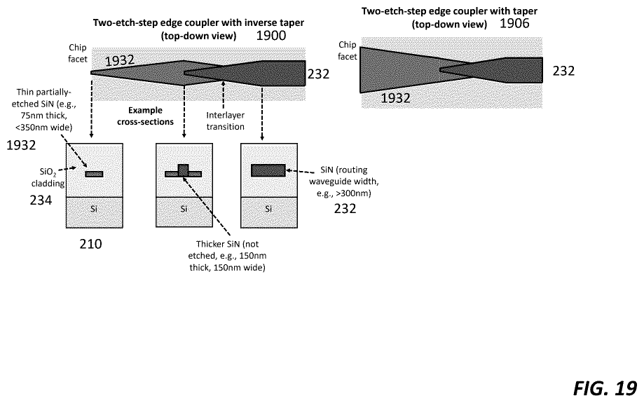

FIG. 19 shows an alternative inverse taper edge coupler 1900 using full and partial etches (two-step etch) of a single waveguide layer to achieve the thin edge coupler thickness for the edge coupler and the larger thickness for compact photonic devices. Low-index waveguide materials 1932 (e.g., SiON or polymers) with thicknesses >1 μm are another possibility for the photonic integrated circuit and waveguides. In this case, the waveguide may be tapered to larger widths at the facet compared to the routing waveguide widths as in the edge coupler 1906 at right. Overall, the ability to shape the beams (divergence and symmetry) via the edge coupler design is beneficial for this approach and can be achieved with multiple designs.

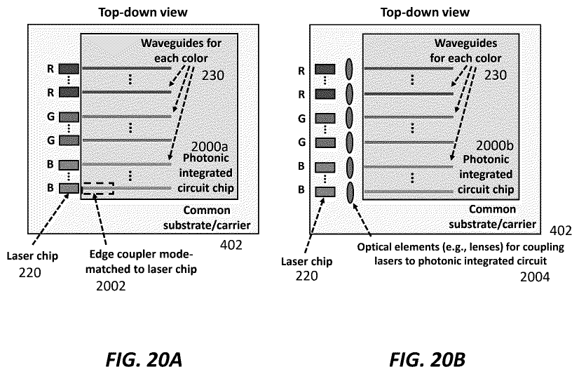

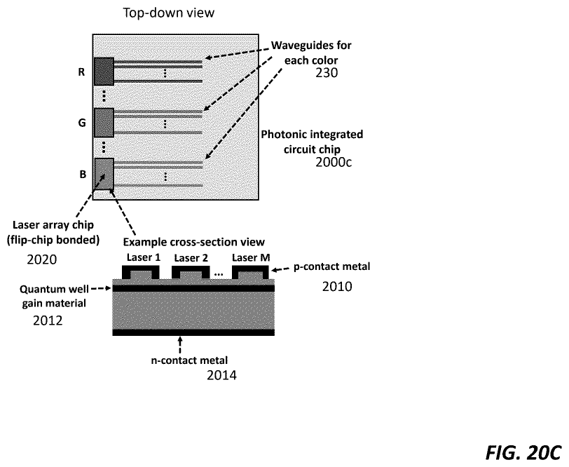

Flip-chip bonding is one method of coupling laser chips 220 to the photonic integrated circuit chip 200. Other possibilities are shown in FIGS. 20A-20C. In FIG. 20A, laser chips 220 are aligned to edge couplers 2002 on the photonic chip 2000a, and both the laser chips 220 and the photonic chip 2000a attached to a common substrate/carrier 402. The chips may be attached to the substrate 402 face-up or flip-chip bonded. In FIG. 20B, the laser chips 220 are coupled to edge couplers in the photonic chip 2000b through small optics 2004 (e.g., lenses) that are also attached to the common substrate/carrier 402 along with the laser chips 220 and the photonic chip 2000b. In FIG. 20C, laser array chips 2020 are (flip-chip) bonded to the photonic chip 2000c. Each laser array chip 2020 includes a set of individual lasers (with a lithographically defined pitch) formed of quantum well gain material 2012 with p-contact metal 2010 on one side and n-contact metal 2014 on the other side. Using laser array chips 2020 instead of individual laser chips may alleviate packaging challenges associated with aligning many laser chips to the photonic integrated circuit chip. In butt-coupling approaches (e.g., as in FIGS. 2, 20A, and 20C), efficient optical coupling involves matching the optical waveguide mode of each edge coupler of the photonic chip 2000c to the waveguide mode of the corresponding laser chip 220.

The edge couplers used for coupling to lasers may be formed from the same layers used for the edge coupler emitters (FIGS. 18 and 19) but with design modifications for matching the optical mode at the edge coupler tip to the transverse optical mode of the laser. Laser modes are often elliptical and similar mode shapes at the edge coupler may be achieved at the edge coupler tip (e.g., by making the edge coupler tip width larger than the tip height). Alternatively, tapered designs (also shown in FIGS. 18 and 19) may be used, where the waveguide width expands at the facet.

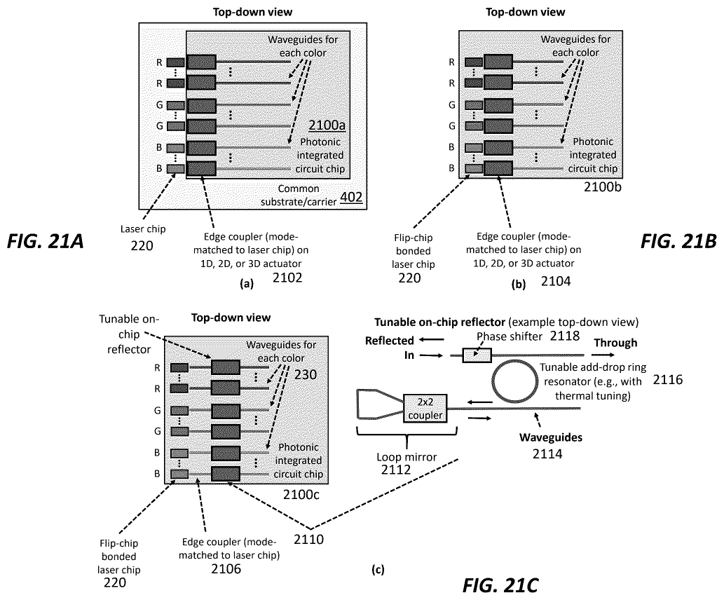

FIGS. 21A-21C show additional possibilities for coupling laser chips to the photonic integrated circuit chip. 1D, 2D, or 3D actuators may be used to translate and/or tilt the input edge couplers 2102, 2104 to optimize the alignment of lasers 220 with respect a photonic chip 2100a bonded to a common carrier 402, as in FIG. 21A, or lasers 220 flip-chip bonded directly to the photonic chip 2100b, as in FIG. 21B

FIG. 21C shows a variation of the laser coupling where tunable waveguide reflectors 2110 on the photonic integrated circuit chip 2100c provide feedback to the laser chips 220. The tunable reflectors 2110 may be tunable in amplitude, reflection spectrum, and/or phase. An example of such a reflector 2110 is an add-drop ring resonator 2116 evanescently coupled to a waveguide 2114 with a waveguide loop mirror 2112 at the drop port; tuning the ring resonator 2116 changes the wavelength of maximum reflectivity and tuning the phase shifter 2118 between the edge coupler and ring resonator 2116 tunes the phase of the reflected light. Tunable feedback to the laser 220 enables tuning of the wavelength, linewidth, and stability of the laser 220.

In variations of the photonic integrated circuit chip with flip-chip bonded lasers (e.g., as in FIG. 2), the lasers may be placed in trenches defined in the wafer substrate surface. These trenches may have pillars defined in them that serve as mechanical stops for accurate height alignment of the laser core and edge coupler when placing the chip (self-alignment). These trenches may also contain on-chip wiring and solder bumps for soldering the laser in place and applying electrical signals to the laser. Flip-chip bonding has been used to mate infrared lasers to photonic chips with Si waveguides.

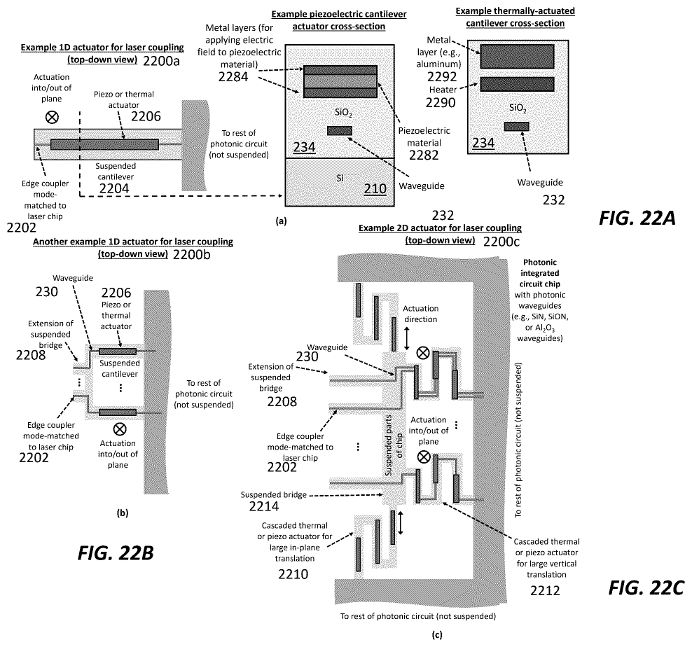

FIGS. 22A-22C show actuators 2200a-2200c suitable for aligning edge couplers to lasers as in FIGS. 21A-21C. Such actuators 2200a-2200c may be based on electro-thermal or piezoelectric actuation and may include suspended cantilevers containing the edge couplers or cascaded cantilever actuators for linear translation of a bridge containing the edge couplers. Cascaded cantilever actuators can provide large vertical and in-plane translation. An actuator formed from a single cantilever with a waveguide can align to lasers and fibers. Following optimal alignment using the actuator, epoxy may be applied to the actuator to fix the actuator's position.

FIG. 22A shows a 1D suspended cantilever actuator 2200a for aligning one or more edge couplers 2202 to lasers. A piezo or electrothermal actuator 2206 bends the cantilever 2204, which tilts and translates the cantilever 2204 and edge coupler 2202 out of the photonic chip plane. A piezoelectric actuator may be formed from a piezoelectric material 2282 sandwiched between two metallic electrodes 2284 (for applying an electric field); the electric field causes the piezoelectric material 2282 to expand or compress, bending the cantilever. Similarly, an electrothermal actuator may be formed of a heater 2290 that heats a nearby metal layer 2292.

FIG. 22B shows another 1D cantilever actuator 2200b with multiple cantilevers, each with its own actuator 2206, connected to a bridge with extensions 2208 containing the edge couplers 2202; the multiple cantilevers may increase the robustness of the suspended structure.

FIG. 22C shows an example 2D actuator 2200c (up/down and in/out-of-plane in the illustration) based on cascaded cantilever actuators 2210, 2212 (e.g., using piezoelectric or electrothermal mechanisms). One or more actuators for each actuation direction are connected to a suspended bridge 2214 containing the edge coupler(s). Cascaded cantilever actuators enable larger translations than simple cantilever actuators, and additionally, can be designed to translate without tilting.

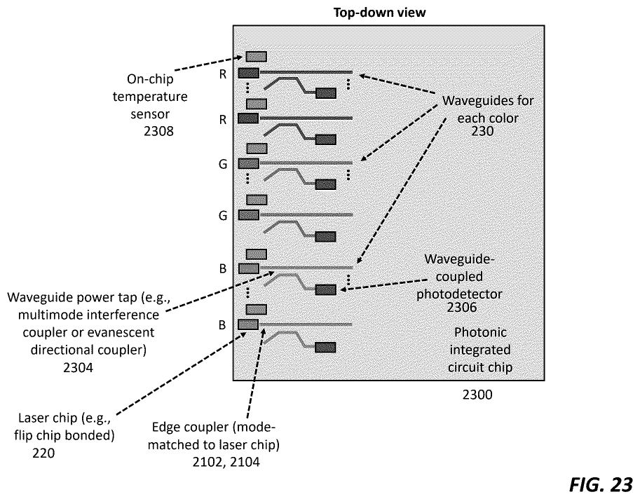

FIG. 23 shows a photonic integrated circuit chip 2300 with laser coupling portion where waveguide power taps 2304 (e.g., multimode interference couplers or evanescent directional couplers) are used to couple a small fraction of the light in each waveguide 230 to an on-chip waveguide-coupled photodetector 2306 for monitoring the power and intensity modulation of the lasers 220. Such waveguide-coupled photodetectors 2306 may include a waveguide (e.g., SiN or Al₂O₃) passing over a patch or mesa of doped Si, wherein a PIN or PN junction is defined.

FIG. 23 also shows that temperature sensors 2308 may be defined on the photonic integrated circuit chip 2300 close to the lasers 220. These temperature sensors 2308 can be used to ensure a stable operating temperature (and wavelength) for the lasers 220. Temperature sensors 2308 may be formed from thin film metal wires or doped Si wires formed on the photonic chip 2300 (in both cases, the electrical resistance changes with temperature, providing a measure of temperature).

The dielectric layers deposited on the thin bridge of the photonic integrated circuit chip may apply stress to the bridge that may warp the bridge (primarily out of the plane of the photonic chip). This warping may be prevented or minimized by an appropriate dielectric layer on the underside of the thin bridge. The stress of this additional layer cancels out the warping from the dielectric layers on top of the bridge. This may also be accomplished by depositing a thin film on top of the bridge that opposes/compensates the stress of other dielectric layers on top of the bridge.

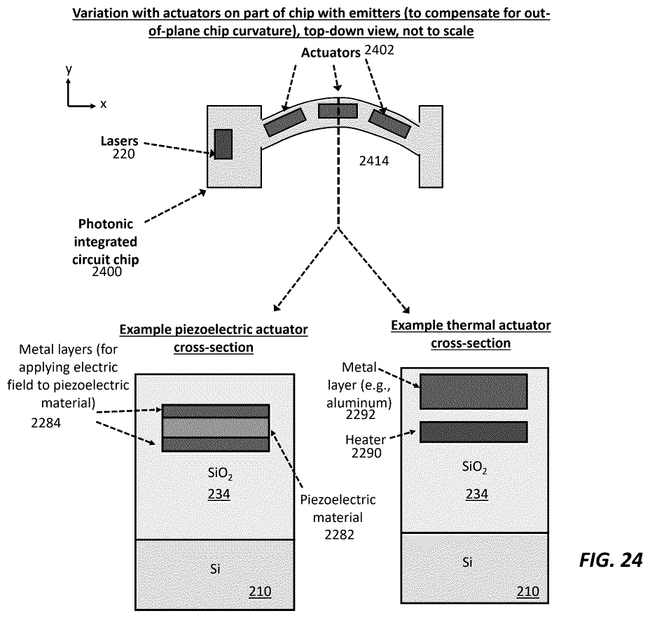

Alternatively, as shown in FIG. 24, actuators 2402 defined on the thin bridge 2414 (e.g., electrothermal or piezoelectric actuators) of the photonic chip 2400 may be used to apply additional stress to the bridge 2414 and prevent warping. Piezoelectric actuators can prevent warping and enhance flatness of MEMS plates (e.g., in the context of MEMS mirrors).

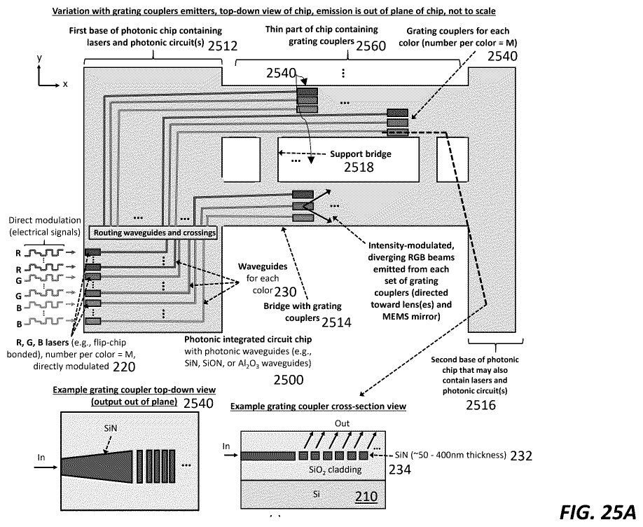

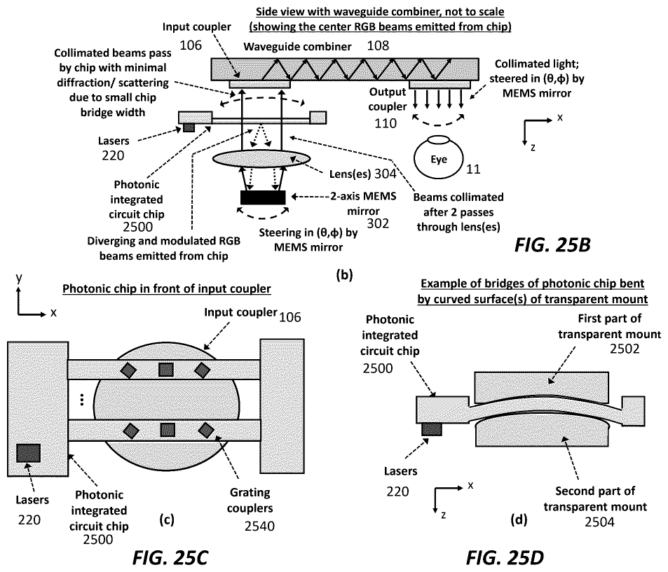

FIGS. 25A-25D show a photonic integrated circuit chip 2500 with grating couplers 2540 (instead of edge couplers) for emitting light. Grating couplers 2540 are diffractive elements defined in the waveguide 230 that can emit light out of the plane of the photonic chip 2500; often defined by etching grooves (“grating teeth”) into the waveguide. Typically, grating couplers 2540 emit light at an angle relative to the normal of the photonic chip 2500 (diffraction angle). The gratings 2540 may be designed to emit round beams, and considering the emission angles of the gratings 2540, the projection of the beams onto the transverse plane of the collimation/relay optics 304 may be designed to be round. The grating width and strength (defining the aperture size) may also be engineered to achieve a certain divergence angle that is compatible with the lens(es) in the light engine.

As in the edge-coupled approach, each row of grating couplers 2540 splits the FOV into slices along one axis, however in contrast, multiple rows of grating couplers 2540 can be defined in the photonic integrated circuit 2500—splitting the FOV along a second axis. In FIG. 25A, a thin part 2560 of the photonic chip 2500 includes one or more bridges 2514 (between bases 2512, 2516 and possibly with supporting beams 2518), which contain the grating couplers 2540 for R, G, and B. In the light engine in FIG. 25B, the photonic chip 2500 is oriented with the normal of the photonic chip surface parallel to the light engine optical axis. The gratings 2540 are formed in the SiN waveguide cores 232 and may be oriented at certain angles to the principal axes of the photonic chip 2500. The bridges 2514 may be curved by engineered stress applied by the dielectric layers deposited on the bridges 2514, actuators on the bridges 2514 (as in FIG. 24), or by pressing the bridges 2514 between one or more curved surfaces of a transparent optical window 2502, 2504, as in FIG. 25D.

### LiDAR Systems

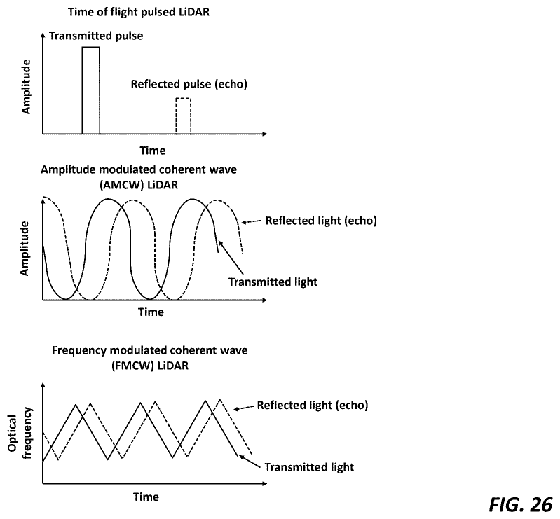

FIG. 26 illustrates three common LiDAR techniques compatible with laser scanning. In time-of-flight pulsed LiDAR (top), at each position of the beam, an optical pulse is emitted and time delay in receiving a reflected (echo) pulse from an object enables calculation of the object's depth. In amplitude-modulated coherent-wave (AMCW) LiDAR (middle), the amplitude of the beam is modulated periodically, and the phase difference of the amplitude modulation between the transmitted light and received reflected light enables calculation of the object's depth. Lastly, in frequency-modulated coherent-wave (FMCW) LiDAR (bottom), the optical frequency of the laser is modulated periodically, and the frequency difference between transmitted light and received reflected light is used to calculate the depth of an object. In all three methods, as the laser beam is scanned across a scene, depth information can be extracted for every beam position.

FMCW LiDAR is often implemented by interfering the received reflected light and a portion of the laser light tapped off before transmission (referred to as the local oscillator (LO) beam). The interference may be performed with a beam splitter or other 2×2 optical coupler, and the two resultant outputs are detected with balanced photodetectors (coherent detection). An optical frequency difference between the LO and reflected light leads to a beat signal in the photocurrent output of the balanced photodetectors, and the beat frequency is used to calculate the depth. AMCW may be performed with coherent detection or by detecting the reflected light with a single photodetector and extracting the phase shift of the amplitude modulation with electronic circuits. Time-of-flight pulsed LiDAR is performed by detecting the reflected pulse with a single photodetector.

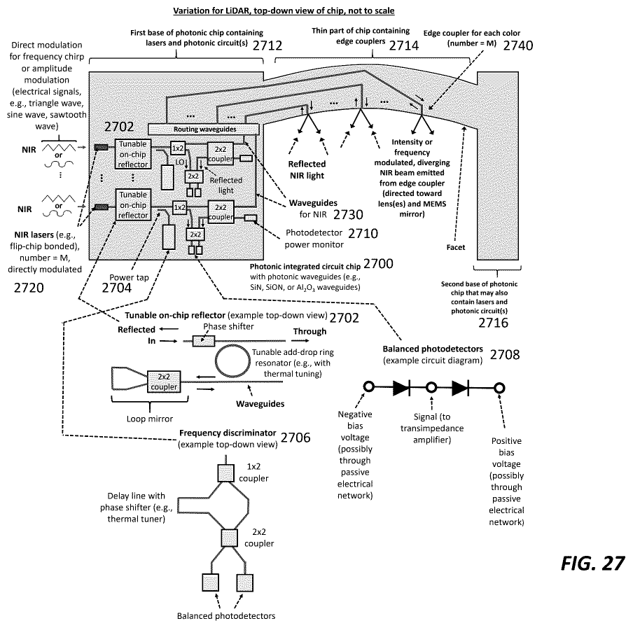

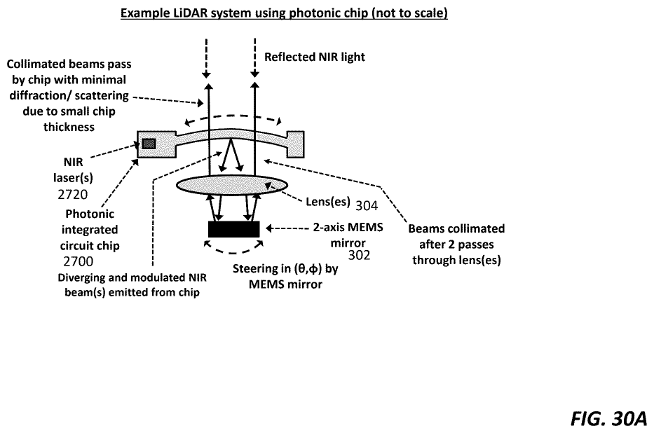

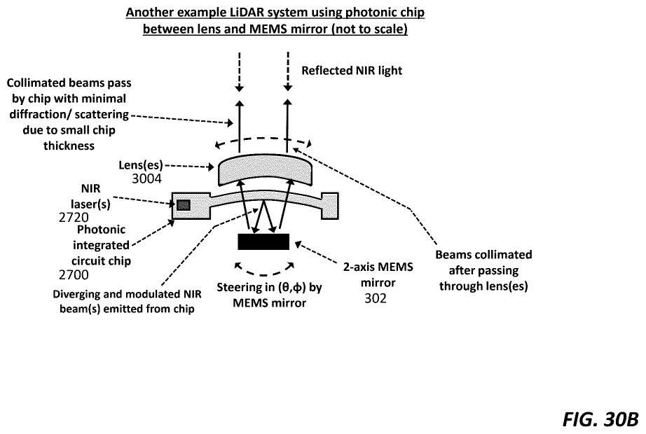

FIG. 27 shows a photonic integrated circuit chip 2700 for FMCW or AMCW LiDAR with coherent detection. Like the photonic chips described above, the photonic chip 2700 has base regions 2712, 2716 connected by a thin bridge region 2714 with edge couplers 2740 for emitting diverging beams. As shown in FIGS. 30A and 30B (described in greater detail below), the diverging beams are collimated by lens(es) and scanned by a two-axis MEMS mirror. Reflected light follows the same path backwards, and the reflected beams are focused by the lens(es) and directed by the MEMS mirror to the edge couplers 2740 from which they were originally emitted. Here, the operating wavelengths are in the NIR (e.g., wavelengths of 850 nm, 905 nm, 940 nm, and/or 1550 nm), and NIR lasers 2720 are flip-chip bonded onto or otherwise co-packaged with the photonic chip 2700 (like those shown in FIGS. 2 and 20-23). The laser wavelengths may be the same or different. In some embodiments, the wavelengths may be different to limit crosstalk between reflected beams received by the photonic chip. In embodiments using wavelengths longer than about 1100 nm (e.g., 1550 nm), Si (e.g., using the Si device layer of a silicon-on-insulator wafer) may be used as the waveguide core material.

FIG. 27 is especially well suited for FWCW LiDAR, and a portion of the light from each laser 2720 is coupled to a separate set of waveguides 2730 to form the local oscillators (LOs). The wavelengths of the lasers 2720 can be the same or different. A portion of the reflected light in each waveguide is coupled into a separate set of waveguides by 2×2 couplers. For each beam, the LO and reflected light are interfered by a 2×2 coupler and detected with on-chip balanced photodetectors 2708. Additional photodetectors 2710 monitor the power levels of the outbound beams. These photodetectors 2708, 2710 may be waveguide-coupled Si photodetectors, which can detect light at wavelengths less than about 1000 nm. Alternatively, for wavelengths longer than about 1100 nm (e.g., 1550 nm), the photodetectors 2708, 2710 may be waveguide-coupled germanium photodetectors. The coherence length of the lasers should be significantly longer than twice the maximum depth measured, and in FIG. 27, power taps 2704 couple laser light to on-chip tunable reflectors 2702, which provide optical feedback to the lasers 2720 for achieving narrow linewidths.

Frequency discriminators 2706 are also used to monitor the optical wavelength, and when combined with control electronics, enable stabilization and tracking of the optical frequency. Tunable reflectors, frequency discriminators, and balanced photodetectors are common elements in LiDAR systems based on photonic integrated circuits. Unlike other LiDAR chips, the photonic integrated circuit chip 2700 here has a unique curved shape, an array of edge couplers 2740 that generates multiple beams, and is integrated with multiple NIR lasers 2720.

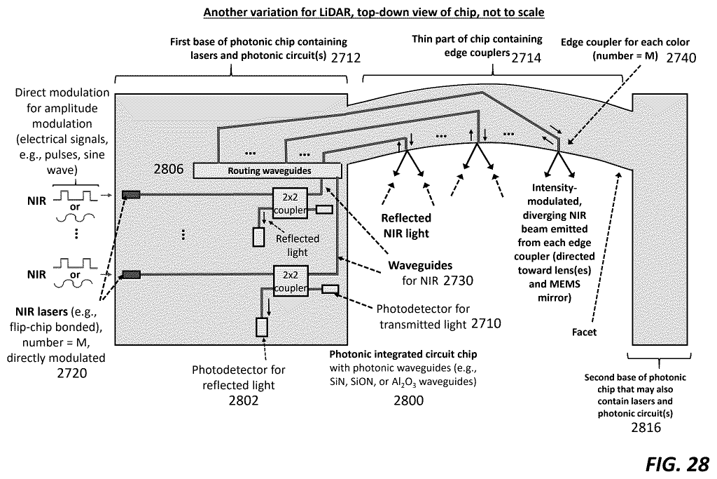

FIG. 28 shows a photonic integrated circuit chip 2800 for time-of-flight pulsed LiDAR or AMCW LiDAR (without coherent detection). Each reflected beam is detected by a single photodetector 2802 and compared to the transmitted beam in the electronic domain. Some embodiments of the photonic chips may include tunable optical filters connected to the photodetectors to filter the reflected light before detection (not shown in FIG. 28). These filters may be used to preferentially transmit the wavelengths of the NIR lasers 2720 and reject ambient light coupled into the photonic chip via the edge couplers. The tunable optical filters may be implemented as cascaded add-drop ring resonator filters, photonic crystal filters, corrugated sidewall grating filters, evanescent directional couplers, echelle gratings, or arrayed waveguide gratings. Integrated resistive heaters positioned above or laterally offset from the filter devices may be used to thermo-optically tune the transmission spectra of the filters to align to the NIR laser wavelengths.

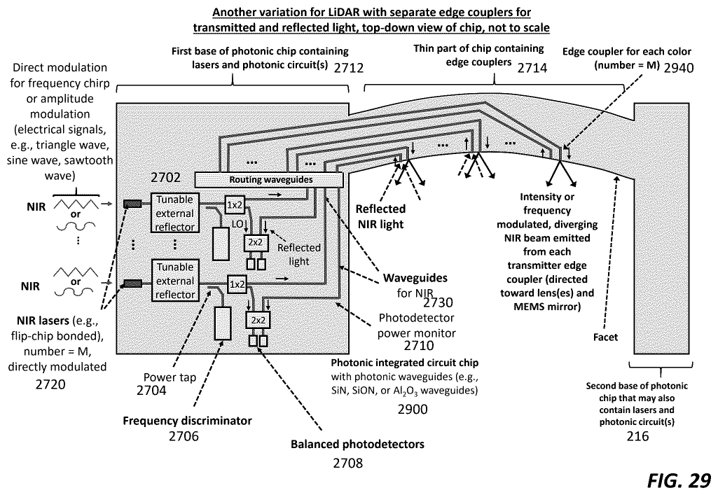

FIG. 29 shows a photonic integrated circuit chip 2900 with pairs of closely spaced edge couplers 2940, with one edge coupler for emitting a beam and the other edge coupler for receiving the reflected light. An advantage of this approach is that it does not need a 2×2 coupler to couple the reflected light into a separate waveguide, e.g., as in FIG. 27. This reduces losses significantly in the transmission and reflection paths. A disadvantage is that the reflected beam may not be exactly focused onto the appropriate edge coupler, which introduces loss.

FIGS. 30A and 30B illustrate LiDAR optical systems that each include a photonic integrated circuit chip 2700 (or 2800 or 2900), lens(es) 304, 3004, a two-axis MEMS mirror 302, and a double-pass configuration. The diverging NIR beams emitted by the photonic chip 2700 are collimated by one or two passes through the lens(es) 304, 3004 and the MEMS mirror 302 scans the collimated beams. Similar to the light engine embodiments, the collimated beams pass by the thin bridge 2714 of the photonic chip 2700 with little to no scattering or diffraction due to the small thickness and depth of the bridge 2714 relative to the beam diameter. Both telecentric (FIG. 30A) and monocentric (FIG. 30B) variations are shown. Though not shown in FIG. 30A or 30B, systems with separate relay and collimation lenses, as in FIG. 11, may be used to increase the FOV and beam diameter.

Other embodiments of LiDAR optical systems may include separate transmitter and receiver modules. The transmitter and receiver modules may have the same configurations as in FIGS. 30A and 30B, and each may include a photonic integrated circuit chip, lens(es), a two-axis MEMS mirror, and a double-pass configuration. During operation, the scanning mirrors of the two modules may be synchronized such that as the transmitter scans beams across a scene, the receiver directs reflected light from each of the beams to corresponding edge couplers in the receiver photonic integrated circuit. This approach may circumvent limitations of the LiDAR system due to light emitted by the edge couplers being coupled back into edge couplers on the second pass through the double-pass optical system and being detected by the photodetectors.

The photonic integrated circuit chips for LiDAR systems can also include the variations shown in FIGS. 4-25, including laser, photodetector, thermal sensor, and edge coupler variations; embodiments with optical switches and/or modulators; different techniques for mounting photonic chips together with optical components in a housing; grating couplers; and actuators on the thin bridge to compensate for deposited thin film stress.

Systems with Simultaneous Light Engine and LiDAR Functionalities

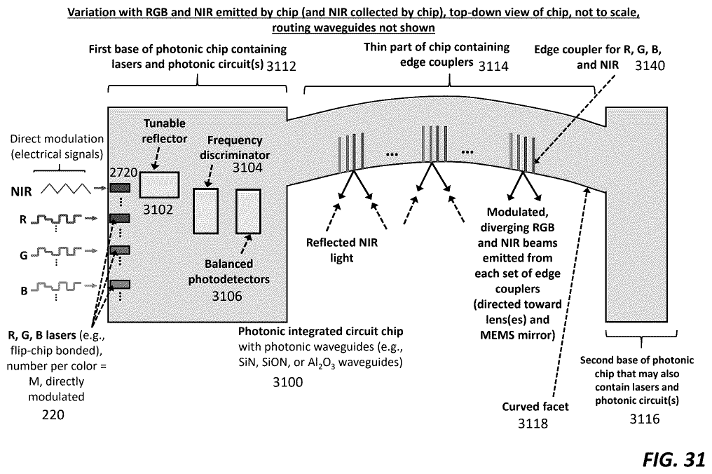

Display and 3D imaging functionalities are useful for augmented reality glasses. FIG. 31 shows a photonic integrated circuit chip 3100 that can be used in an optical system with lenses, scanning mirrors, and a double-pass configuration to provide light engine and LiDAR functionalities simultaneously. R, G, B, and NIR lasers 220, 2720 are flip-chip bonded onto or otherwise co-packaged with the photonic chip 3100. Arrays of edge couplers 3140 along the curved facet 3118 of the thin bridge 3114 between bases 3112 and 3116 emit diverging visible and NIR beams. In addition, reflected NIR light is collected by some of the edge couplers 3140 and detected on one of the bases 3112 of the photonic chip 3100. Tunable reflectors 3102, frequency discriminators 3104, and balanced photodetectors 3106 on the base 3112 of the photonic chip 3100 enable time-of-flight pulsed, AMCW, or FMCW LiDAR.

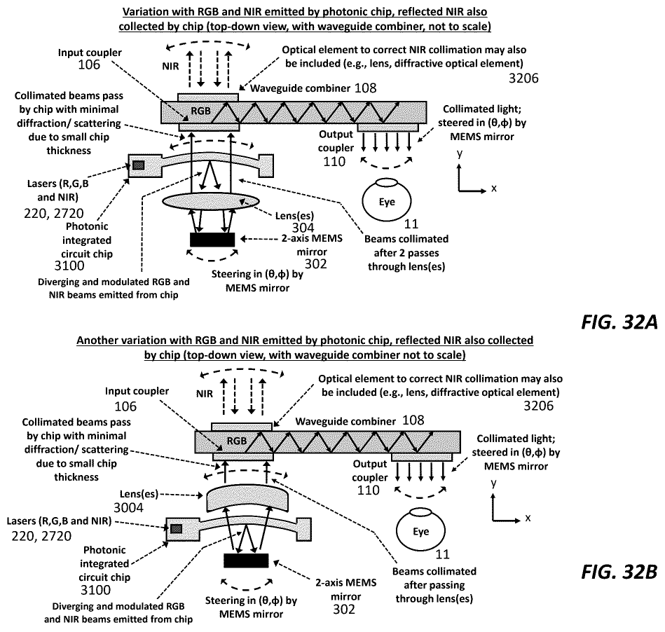

FIGS. 32A and 32B show an optical system together with a waveguide combiner 108 and different lens configurations (telecentric, monocentric Type 1). Scanned RGB beams are coupled into the waveguide combiner 108 via the input coupler 106, as in FIGS. 3, 9, and 11, while scanned NIR beams pass through the input coupler 106 and waveguide combiner 108 for imaging of the user's surroundings. Reflected NIR beams also pass through the waveguide combiner 108 and input coupler 106 and are coupled back onto the photonic chip 3100 via the edge couplers 3140. One or more optical elements (e.g., lenses or diffractive optical elements) on the outside of the waveguide combiner may be used to correct for divergence in the emitted NIR beams due to chromatic aberration from the lens(es); some aberration is expected for operation of the lenses across blue-NIR wavelengths. Some of these optical elements (e.g., lenses 304, 3004) on the outside of the waveguide combiner 108 may be used to expand the scan angle (FOV) of the scanned NIR beams (at the expense of increasing the beam divergence). Though not shown in FIG. 32A or 32B, systems based on a separate collimator and relay lenses, as in FIG. 11, are also possible (telecentric, monocentric Type 2).

### Fabrication and Substrate Details

The photonic chips described herein may be fabricated on several different wafer substrates. The photonic chips may be fabricated on bulk Si, silicon on insulator (SOI), double SOI, glass, sapphire, or lithium niobate on insulator (LNOI) wafers, to name a few. SOI wafers may further be divided into wafers with a thin Si device layer (thickness <1 μm, often used for Si photonics applications) and wafers with a thick Si device layer (thickness ˜ 5-150 μm, often used for MEMS applications).

Trenches may be etched into the front of the wafer to define the photonic chip shape and edge coupler facets. The whole wafer may be thinned (e.g., by backgrinding or etching) to thin and separate the photonic chips from the wafer (resulting in chips where the base and bridge thickness may be equal). Alternatively, the backside of the wafer may be patterned with trenches to selectively thin the bridges and separate the photonic chips from the wafer (resulting in chips where the base thickness can be larger than the bridge thickness).

The magnitude of optical scattering and diffraction by the thin bridge of the photonic chip can affect the choice of substrate. In thin bridges with a Si backbone formed from a Si substrate or Si device layer, the Si is opaque to visible and NIR light and can scatter/diffract incident light. Reducing the Si thickness should reduce the scattering/diffraction at the expense of the mechanical stiffness and strength of the bridge, potentially increasing curvature of the bridge due to film stress and increasing the probability of the photonic chip failing due to the bridge fracturing.

An alternative strategy to reduce the optical scattering/diffraction is to use a glass wafer substrate. Fabrication steps may be performed on glass wafers to define waveguides, photodetectors, phase shifters, structures for bonding of laser chips, and other devices. Front-side trench etching and backside wafer thinning or etching may be used to define the photonic chip shape. If such glass photonic integrated chips are embedded in a glass window, e.g., as in FIG. 12B, or in a lens, e.g., as in FIG. 9C, with epoxy filling any air gaps, the transparency of the glass chip to visible and NIR light should significantly reduce optical scattering and diffraction from the photonic chip.

Another alternative strategy using Si or SOI substrates is to fix at least the top surface of the bridge region of the photonic chip to a transparent substrate or support structure (e.g., a glass or polymer, which may or may not have the same or similar lateral dimensions as the bridge) and completely remove (or greatly reduce the thickness of) the Si in the bridge (e.g., by etching) without modifying the dielectric waveguide or cladding layers on the top surface of the bridge. In this case, the transparent substrate/support structure provides mechanical strength to the thinned bridge region, which could be completely or nearly transparent.

### CONCLUSION

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain, using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A photonic integrated circuit chip comprising:
a substrate formed into a base region and a curved bridge extending from the base region;
lasers, integrated into the base region, to emit light;
edge couplers, integrated into the curved bridge, to couple the light into free space; and
waveguides, connecting the lasers to the edge couplers, to guide the light from the lasers to the edge couplers.

2. The photonic integrated circuit chip of claim 1, wherein the base region is thicker than the curved bridge.

3. The photonic integrated circuit chip of claim 1, wherein the base region and the curved bridge have the same thickness.

4. The photonic integrated circuit chip of claim 1, wherein the edge couplers have flat facets in the curved bridge for emitting the light into free space.

5. The photonic integrated circuit chip of claim 1, wherein the edge couplers have curved facets in the curved bridge for emitting the light into free space.

6. The photonic integrated circuit chip of claim 1, wherein the edge couplers have staggered, cantilevered facets for emitting the light into free space.

7. The photonic integrated circuit chip of claim 1, wherein the edge couplers are configured to emit parallel beams of light.

8. The photonic integrated circuit chip of claim 1, wherein the edge couplers are configured to emit non-parallel beams of light.

9. The photonic integrated circuit chip of claim 1, wherein each of the edge couplers is configured to address a different slice of a field of view illuminated by the light.

10. The photonic integrated circuit chip of claim 1, wherein the edge couplers are configured to emit the light out of a plane of the photonic integrated circuit chip.

11. The photonic integrated circuit chip of claim 1, wherein each of the edge couplers is configured to emit the light in a direction normal to a curvature of a facet of that edge coupler.

12. The photonic integrated circuit chip of claim 1, further comprising:
optical switches, integrated into the base region in optical communication with the lasers and the waveguides, to route the light from the lasers to the waveguides.

13. The photonic integrated circuit chip of claim 1, further comprising:
optical modulators, integrated into the base region in optical communication with the lasers and the waveguides, to modulate the light.

14. The photonic integrated circuit chip of claim 1, wherein the lasers comprise a red laser to emit red light, a green laser to emit green light, and a blue laser to emit blue light, and further comprising:
a wavelength multiplexer, in optical communication with the red laser, the blue laser, and the green laser, to multiplex the red light, the green light, and the blue light onto one of the waveguides.

15. The photonic integrated circuit chip of claim 1, further comprising:
actuators, operably coupled to the curved bridge, to apply stress to the curved bridge to prevent warping.

16. The photonic integrated circuit chip of claim 1, wherein the edge couplers are further configured to couple scattered and/or reflected light from free space into the waveguides, and further comprising:
photodetectors, integrated into the base region, to detect the scattered and/or reflected light.

17. The photonic integrated circuit chip of claim 16, wherein the lasers are configured to emit red light, green light, blue light, and near-infrared (NIR) light and the photodetectors are configured to detected scattered and/or reflected NIR light.

18. The photonic integrated circuit chip of claim 1, wherein the base region is a first base region coupled to a first end of the curved bridge and further comprising:
a second base region coupled to a second end of the curved bridge.

19. A light engine for an augmented reality display comprising:
the photonic integrated circuit chip of claim 1;
an optical combiner, in optical communication with the edge couplers, to couple the light from the edge couplers towards an eye of a person viewing the augmented reality display;
at least one lens, in optical communication with the photonic integrated circuit chip and the optical combiner, to couple light from the photonic integrated circuit chip into the optical combiner; and
a beam-scanning element, in optical communication with the at least one lens, to scan the light across a field of view of the eye of the person viewing the augmented reality display.

20. The light engine of claim 19, further comprising:
a printed circuit board or carrier supporting the photonic integrated circuit chip.

21. The light engine of claim 19, wherein the photonic integrated circuit chip and the at least one lens are disposed between the optical combiner and the beam-scanning element and the beam-scanning element is configured to reflect the light past the photonic integrated circuit chip and through the at least one lens to the optical combiner.

22. The light engine of claim 19, wherein the photonic integrated circuit chip, the at least one lens, and the beam-scanning element are in line with each other and an input coupler of the optical combiner.

23. A light engine for an augmented reality display comprising:
a first photonic integrated circuit chip according to claim 1; and
a second photonic integrated circuit chip according to claim 1 stacked on the first photonic integrated circuit chip.
